(19) United States
(12) Patent Application Publication
(10) Pub. No.: US 2026/0169404 A1
(43) Pub. Date: Jun. 18, 2026

(54) MEDIUM PROCESSING APPARATUS AND IMAGE FORMING SYSTEM

(71) Applicants: Shohei SAITO, Kanagawa (JP); Keisuke SUGIYAMA, Kanagawa (JP); Kei SASAKI, Kanagawa (JP); Kazuki SETO, Kanagawa (JP); Sachika TAMAKI, Kanagawa (JP); Kohta ABE, Kanagawa (JP); Takashi YAMAMOTO, Kanagawa (JP)

(72) Inventors: Shohei SAITO, Kanagawa (JP); Keisuke SUGIYAMA, Kanagawa (JP); Kei SASAKI, Kanagawa (JP); Kazuki SETO, Kanagawa (JP); Sachika TAMAKI, Kanagawa (JP); Kohta ABE, Kanagawa (JP); Takashi YAMAMOTO, Kanagawa (JP)

(73) Assignee: Ricoh Company, Ltd., Ohta-ku, Tokyo (JP)

(21) Appl. No.: 19/127,254

(22) PCT Filed: Jan. 11, 2024
(86) PCT No.: PCT/IB2024/050262

§ 371 Date: May 5, 2025

(30) Foreign Application Priority Data
Jan. 12, 2023 (JP) 2023-003318
Oct. 27, 2023 (JP) 2023-185023

(51) Int. Cl. G03G 15/10; B41J 2/005; B41J 2/045; B41J 2/165; B41J 2/175

(52) U.S. Cl. CPC G03G 15/105; B41J 2/0057; B41J 2/04586; B41J 2/16526; B41J 2/17566

(57) ABSTRACT

A medium processing apparatus includes: a liquid applier to apply liquid to a part of at least one medium; a post-processing device to perform processing on a bundle of media including the at least one medium; a first liquid storage disposed in the liquid applier; a second liquid storage to store the liquid to be supplied to the first liquid storage; a liquid supplier to supply the liquid from the second liquid storage to the first liquid storage; a first liquid detector to detect the liquid in the first liquid storage; and a controller to control an operation of the liquid supplier in accordance with a detection result of the first liquid detector. The liquid applier includes a liquid absorber having a portion to be partially immersed in the liquid stored in the first liquid storage and another portion to contact the at least one medium to apply the liquid.

### TECHNICAL FIELD

Embodiments of the present disclosure relate to a medium processing apparatus, an image forming system, and a medium processing method.

### BACKGROUND ART

Various types of medium processing apparatuses are known that bind a sheet bundle of stacked sheet media. Such medium processing apparatuses employ binding processes including, for example, a “stapling process” for penetrating needle-shaped members (binding members) through a sheet bundle to bind the sheet bundle and a “crimping process” for applying pressure to and deform a part of a sheet bundle to bind the sheet bundle.

A technique is disclosed in which, for the purpose of applying liquid to paper sheets serving as sheet media in crimping, liquid is applied by passing a belt through a water tank storing the liquid and bringing the belt attached with moisture into contact with a part of the paper sheets to be crimped (e.g., see Patent Literature (PTL) 1).

### CITATION LIST

### Patent Literature

### [PTL 1]

Japanese Patent No. 3502204

### SUMMARY OF INVENTION

### Technical Problem

When liquid is applied to a to-be-crimped portion of a paper sheet via a liquid applier (belt) as in the related art disclosed in PTL 1, there is no means for controlling the liquid holding amount of the liquid applier. In other words, there is a problem in controlling the amount of moisture to be applied to the to-be-crimped portion to an appropriate amount.

An object of the present disclosure is a medium processing apparatus that controls the liquid holding amount of a liquid applier that applies liquid to a to-be-crimped portion and enhance the quality of crimping.

### Solution to Problem

In order to solve the above-described problem, according to an aspect of the present disclosure, a medium processing apparatus includes a liquid applier, a post-processing device, a first liquid storage, a second liquid storage, a liquid supplier, a first liquid detector, and a controller. The liquid applier applies liquid to a part of at least one medium. The post-processing device performs processing on a bundle of media including the at least one medium to which the liquid is applied by the liquid applier. The first liquid storage is disposed in the liquid applier to store the liquid to be applied by the liquid applier. The second liquid storage stores the liquid to be supplied to the first liquid storage. The liquid supplier supplies the liquid from the second liquid storage to the first liquid storage. The first liquid detector detects the liquid in the first liquid storage. The controller controls an operation of the liquid supplier in accordance with a detection result of the first liquid detector. The liquid applier includes a liquid absorber. The liquid absorber has a portion to be partially immersed in the liquid stored in the first liquid storage and another portion to contact the at least one medium to apply the liquid.

### Advantageous Effects of Invention

According to one or more embodiments of the present disclosure, the liquid holding amount of the liquid applier that applies liquid to the to-be-crimped portion can be controlled, and the quality of crimping can be enhanced.

### BRIEF DESCRIPTION OF DRAWINGS

A more complete appreciation of embodiments of the present disclosure and many of the attendant advantages and features thereof can be readily obtained and understood from the following detailed description with reference to the accompanying drawings.

FIG. 1 is a diagram illustrating an overall configuration of an image forming system according to an embodiment of the present disclosure.

FIG. 2 is a diagram illustrating the internal structure of a post-processing apparatus according to an embodiment of the present disclosure.

FIG. 3 is a schematic view of an edge binder according to an embodiment of the present disclosure, viewed from an upstream side in a conveyance direction.

FIG. 4 is a schematic view of the edge binder of FIG. 3 as viewed from the side on which a liquid applier is disposed in a main scanning direction. FIG. 5

FIGS. 5A and 5B are schematic diagrams illustrating a configuration of a crimper according to an embodiment of the present disclosure.

FIG. 6 is a schematic view of a staple binder according to an embodiment of the present disclosure, viewed from an upstream side in a conveyance direction.

FIG. 7 is a schematic view of a staple binder as a modification of the staple binder of FIG. 6, viewed from the upstream side in the conveyance direction.

FIG. 8 is a diagram illustrating a hardware configuration of a control block for controlling an operation of a post-processing apparatus according to an embodiment of the present disclosure.

FIG. 9 is a flowchart of a binding process performed by an edge binder according to an embodiment of the present disclosure.

FIG. 10 FIGS. 10A, 10B, and 10C are diagrams illustrating the positions of a liquid applier and a crimper during the binding process of FIG. 9 by the edge binder.

FIG. 11 is a diagram illustrating a configuration of a liquid application portion included in a liquid applier according to a first embodiment of the present disclosure.

FIG. 12 FIGS. 12A, 12B, and 12C are diagrams illustrating a change in the amount of liquid in a liquid storage tank in a dry state of a liquid supply member according to an embodiment of the present disclosure.

FIG. 13 including FIGS. 13A and 13B is a flowchart of a liquid supply determination process according to an embodiment of the present disclosure.

FIG. 14 is a diagram illustrating liquid leakage that might occur in a first liquid storage tank according to an embodiment of the present disclosure.

FIG. 15 is a graph illustrating the relation between the output value of a first liquid-level sensor and the liquid detection threshold value in a time series manner according to an embodiment of the present disclosure.

FIG. 16 is a diagram illustrating replenishment of liquid to a second liquid storage tank according to an embodiment of the present disclosure.

FIG. 17 is a diagram illustrating a configuration of a liquid applier according to a second embodiment of the present disclosure.

FIG. 18 is a flowchart of a liquid-detection threshold-value setting process according to an embodiment of the present disclosure.

FIG. 19 FIGS. 19A and 19B are diagrams illustrating a first example of a liquid application portion included in the liquid applier according to the third embodiment.

FIG. 20 FIGS. 20A and 20B are diagrams illustrating a second example of the liquid application portion included in the liquid applier according to the third embodiment.

FIG. 21 is a diagram illustrating the internal configuration of a post-processing apparatus according to another embodiment of the present disclosure.

FIG. 22 FIGS. 22A, 22B, and 22C are schematic views of an internal tray of the post-processing apparatus of FIG. 21, viewed from a thickness direction of a sheet. FIG. 23 is a schematic view of a crimper of the post-processing apparatus of FIG. 21, viewed from a downstream side in a conveyance direction.

FIG. 24 FIGS. 24A and 24B are schematic views of a liquid application unit of the post-processing apparatus of FIG. 21, viewed from the thickness direction of a sheet.

FIG. 25 FIGS. 25A, 25B, and 25C are cross-sectional views of the liquid application unit taken along a line XXV-XXV of FIG. 24A.

FIG. 26 FIGS. 26A, 26B, and 26C are cross-sectional views of the liquid application unit taken along a line XXVI-XXVI of FIG. 24A.

FIG. 27 is a diagram illustrating a hardware configuration of a control block of the post-processing apparatus of FIG. 21.

FIG. 28 is a flowchart of post-processing performed by the post-processing apparatus of FIG. 21.

FIG. 29 is a diagram illustrating an overall configuration of an image forming system according to a modification of the embodiment illustrated in FIG. 1.

FIG. 30 FIGS. 30A and 30B are schematic views of a post-processing apparatus including controllers a first modification of the embodiment illustrated in FIG. 1.

FIG. 31 FIGS. 31A and 31B are schematic views of a post-processing apparatus including controllers a second modification of the embodiment illustrated in FIG. 1.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DESCRIPTION OF EMBODIMENTS

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Embodiments of the present disclosure are described below in detail with reference to the drawings. In the drawings, the same or similar components are denoted by the same reference codes, and redundant description thereof will be omitted as appropriate.

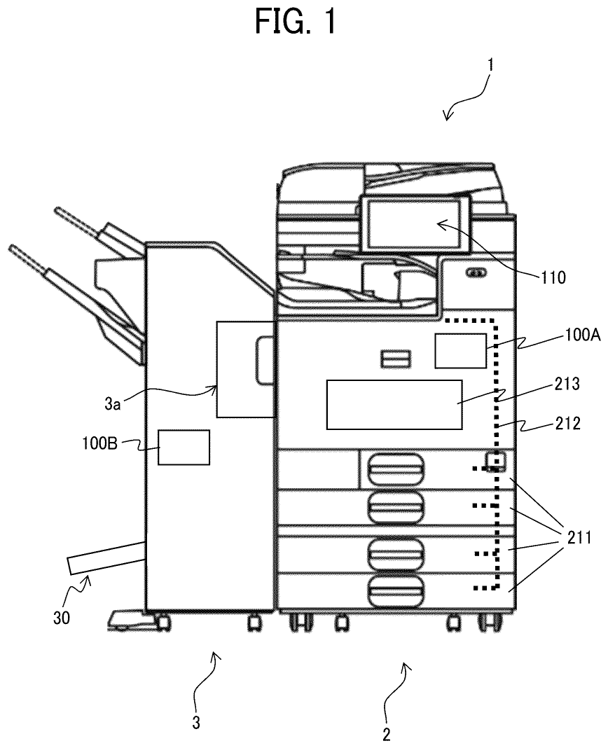

A description is given below of an image forming system 1 according to an embodiment of the present disclosure, with reference to FIG. 1. FIG. 1 is a diagram illustrating an overall configuration of the image forming system 1. The image forming system 1 has, for example, a function of forming an image on a sheet of paper P as a sheet medium and a function of performing post-processing on the sheet of paper P, on which the image has been formed, as post-image-formation processing. As illustrated in FIG. 1, the image forming system 1 includes an image forming apparatus 2 and a post-processing apparatus 3 serving as a medium processing apparatus according to an embodiment of the present disclosure. In the image forming system 1, the image forming apparatus 2 and the post-processing apparatus 3 operate in conjunction with each other.

In the present embodiment, the medium to be processed in the image forming system 1 is described on the assumption that the medium is a sheet of “paper”. However, the medium to be processed is not limited to paper, and any medium can be used as long as it is a medium on which an image can be formed in a known image forming process and is an object of a folding process or a binding process.

The image forming apparatus 2 forms an image on a sheet of paper P, which is referred to simply as sheet P below, and ejects the sheet P, on which the image has been formed, to the post-processing apparatus 3. The image forming apparatus 2 includes an accommodation tray 211 that accommodates the sheet P, a conveyor 212 that conveys the sheet P accommodated in the accommodation tray 211, and an image former 213 that forms an image on the sheet P conveyed by the conveyor 212. The image former 213 may be an inkjet system that forms an image using ink or an electrophotographic system that forms an image using toner. The image forming apparatus 2 also includes a controller 100A that controls various operations of the conveyor 212 and the image former 213. Since the image forming apparatus 2 has a typical configuration, a detailed description of the configuration and functions of the image forming apparatus 2 are omitted.

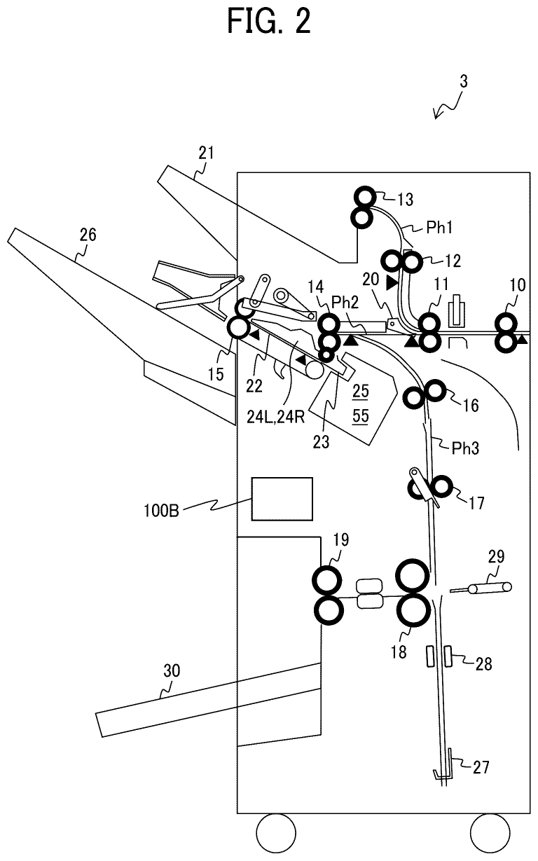

FIG. 2 is a diagram illustrating an internal configuration of the post-processing apparatus 3, according to an embodiment of the present disclosure. The post-processing apparatus 3 has a function that performs post-processing on the sheet P on which an image is formed by the image forming apparatus 2. An example of the post-processing according to the present embodiment is a binding process as a “crimping process” that binds, without staples, a plurality of sheets P on each of which an image is formed as a bundle of sheets P, which may be referred to as a sheet bundle. Another example of the post-processing according to the present embodiment is a binding process as a “stapling process” that binds, with staples, a plurality of the sheets P on each of which an image is formed as a bundle of sheets P (i.e., sheet bundle). In the following description, the bundle of sheets P may be referred to as a “sheet bundle Pb” as a bundle of media. In the present embodiment, a description is given of a liquid application process in a crimping process. However, the liquid application process related to a stapling process is similar to the liquid application process in the crimping process.

More specifically, the “crimping process” according to the present embodiment is a process called “crimping” of applying pressure to a binding position corresponding to a part of sheets P of a sheet bundle Pb to deform (pressure-deform) the binding position to bind the sheet bundle Pb. Examples of the binding process that can be executed by the post-processing apparatus 3 include edge binding and saddle binding. The edge binding is a process to bind an edge of the sheet bundle Pb. The saddle binding is a process to bind the center of the sheet bundle Pb.

The post-processing apparatus 3 includes conveyance roller pairs 10 to 19 serving as conveyors and a switching plate 20. The conveyance roller pairs 10 to 19 convey, inside the post-processing apparatus 3, the sheet P supplied from the image forming apparatus 2. Specifically, the conveyance roller pairs 10 to 13 convey the sheet P along a first conveyance passage Ph1. The conveyance roller pairs 14 and 15 convey the sheet P along a second conveyance passage Ph2. The conveyance roller pairs 16 to 19 convey the sheet P along a third conveyance passage Ph3.

The first conveyance passage Ph1 is a passage extending to an output tray 21 from a supply port through which the sheet P is supplied from the image forming apparatus 2. The second conveyance passage Ph2 is a passage branching from the first conveyance passage Ph1 between the conveyance roller pairs 11 and 14 in a conveyance direction and extending to an output tray 26 via an internal tray 22. The third conveyance passage Ph3 is a passage branching from the first conveyance passage Ph1 between the conveyance roller pairs 11 and 14 in the conveyance direction and extending to an output tray 30.

The switching plate 20 serving as a switcher is disposed at a branching position of the first conveyance passage Ph1 and the second conveyance passage Ph2. The switching plate 20 can be switched between a first position and a second position. The switching plate 20 in the first position guides the sheet P to be ejected to the output tray 21 through the first conveyance passage Ph1. The switching plate 20 in the second position guides the sheet P conveyed through the first conveyance passage Ph1 to the second conveyance passage Ph2. When a trailing end of the sheet P entering the second conveyance passage Ph2 passes through the conveyance roller pair 11, the conveyance roller pair 14 is rotated in reverse to guide the sheet P to the third conveyance passage Ph3. The post-processing apparatus 3 further includes a plurality of sensors that detects the positions of the sheet P in the first conveyance passage Ph1, the second conveyance passage Ph2, and the third conveyance passage Ph3. Each of the multiple sensors is indicated by a black triangle in FIG. 2.

The post-processing apparatus 3 includes the output tray 21. The sheet P that is ejected through the first conveyance passage Ph1 rests on the output tray 21. Among the sheets P supplied from the image forming apparatus 2, a sheet P not subjected to the binding process is ejected to the output tray 21.

The post-processing apparatus 3 further includes the internal tray 22 serving as a placement tray, an end fence 23, side fences 24L and 24R, an edge binder 25, a staple binder 55 serving as a stapler, and the output tray 26. The internal tray 22, the end fence 23, the side fences 24L and 24R, the edge binder 25, and the staple binder 55 perform the edge binding on the sheet bundle Pb of a plurality of sheets P conveyed to the internal tray 22 from the second conveyance passage Ph2.

The “edge binding” includes “parallel binding,” “oblique binding,” and “vertical binding.” The “parallel binding” is a process of binding the sheet bundle Pb along one side of the sheet bundle Pb parallel to the main scanning direction. The “oblique binding” is a process of binding a corner of the sheet bundle Pb. The “vertical binding” is a process of binding the sheet bundle Pb along one side of the sheet bundle Pb parallel to the conveyance direction.

Among the sheets P supplied from the image forming apparatus 2, the sheet bundle Pb subjected to the edge binding is ejected to the output tray 26. In the following description, the direction in which the sheet P is conveyed from the conveyance roller pair 15 toward the end fence 23 is defined as a “conveyance direction” of the sheet P. In other words, the “conveyance direction” herein corresponds to a direction in which the sheet P that has been ejected from the image forming apparatus 2 is moved toward the output tray 26 by, for example, the conveyance roller pair 10 and then is moved toward the end fence 23 by the conveyance roller pair 15. The direction that is orthogonal to the conveyance direction and a thickness direction of the sheet P is defined as a “main scanning direction” or a “width direction of the sheet P.”

The sheets P that are sequentially conveyed through the second conveyance passage Ph2 are temporarily placed on the internal tray 22 serving as a placement tray. The end fence 23 aligns the position, in the conveyance direction, of the sheet P or the sheet bundle Pb placed on the internal tray 22. The side fences 24L and 24R align the position, in the main scanning direction, of the sheet P or the sheet bundle Pb placed on the internal tray 22. The edge binder 25 and the staple binder 55 bind an end of the sheet bundle Pb aligned by the end fence 23 and the side fences 24L and 24R. Then, the conveyance roller pair 15 ejects the sheet bundle Pb subjected to the edge binding to the output tray 26.

A detailed description is given below of the edge binder 25.

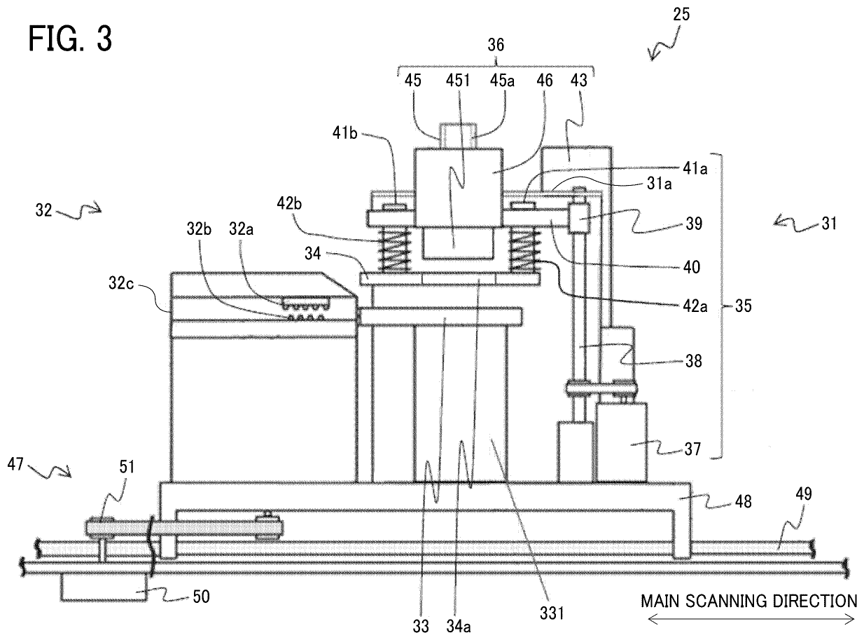

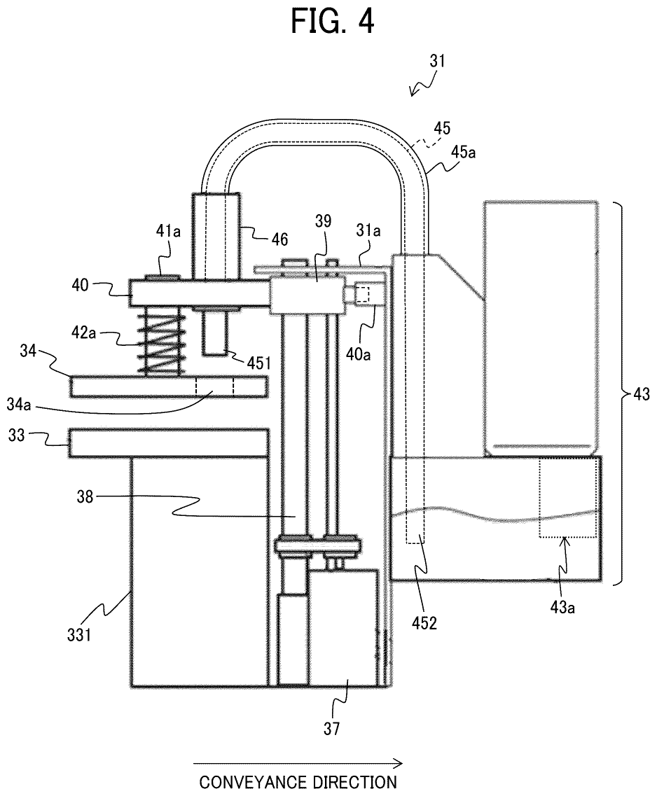

FIG. 3 is a schematic view of an upstream side of the edge binder 25 in the conveyance direction. The edge binder 25 performs a liquid application process and a crimping process. FIG. 4 is a schematic view of a liquid applier 31 of the edge binder 25 when viewed from the main scanning direction. As illustrated in FIG. 3, the edge binder 25 includes the liquid applier 31 and a crimper 32. The liquid applier 31 executes a liquid application process. The crimper 32 serves as a post-processing device and executes a crimping process. The liquid applier 31 and the crimper 32 are disposed downstream from the internal tray 22 in the conveyance direction and adjacent to each other in the main scanning direction.

The liquid applier 31 applies liquid that is stored in a first liquid storage tank 43 serving as a first liquid storage to the sheet P or the sheet bundle Pb placed on the internal tray 22. The application of the liquid to the sheet P or the sheet bundle Pb by the liquid applier 31 and the operation of the liquid applier 31 in applying the liquid are referred to as “liquid application” below. The liquid applying operation of the liquid applier 31 involving control processing is referred to as a “liquid application process”.

More specifically, the liquid that is stored in the first liquid storage tank 43 for the “liquid application” includes, as a main component, a liquid hydrogen-oxygen compound represented by the chemical formula H2O. The liquid hydrogen-oxygen compound is at any temperature. For example, the liquid hydrogen-oxygen compound may be so-called warm water or hot water. The liquid hydrogen-oxygen compound is not limited to pure water. The liquid hydrogen-oxygen compound may be purified water or may contain ionized salts. The metal ion content ranges from so-called soft water to ultrahard water. In other words, the liquid hydrogen-oxygen compound is at any hardness.

The liquid that is stored in the first liquid storage tank 43 may include an additive in addition to the main component. The liquid that is stored in the first liquid storage tank 43 may include residual chlorine used as tap water. Preferably, for example, the liquid that is stored in the first liquid storage tank 43 may include, as an additive, a colorant, a penetrant, a pH adjuster, a preservative such as phenoxyethanol, a drying inhibitor such as glycerin, or a combination thereof. Since water is used as a component of ink used for inkjet printers or ink used for water-based pens, such water or ink may be used for the “liquid application.”

The water is not limited to the specific examples described above. The water may be water in a broad sense such as hypochlorous acid water or an ethanol aqueous solution diluted for disinfection. However, tap water may be used simply to enhance the binding strength after the binding process because tap water is easy to obtain and store. A liquid including water as a main component as exemplified above enhances the binding strength of the sheet bundle Pb, as compared with a liquid of which the main component is not water.

As illustrated in FIGS. 3 and 4, the liquid applier 31 can be moved in the main scanning direction together with the crimper 32 by a driving force transmitted from a first binder movement motor 50. The liquid applier 31 includes a lower pressure plate 33 serving as a placement table for the sheet P or the sheet bundle Pb, an upper pressure plate 34, a liquid-applier movement assembly 35, and a liquid application assembly 36. The components of the liquid applier 31 such as the lower pressure plate 33, the upper pressure plate 34, the liquid-applier movement assembly 35, and the liquid application assembly 36 are held by a liquid application frame 31a and a base 48.

The lower pressure plate 33 and the upper pressure plate 34 are disposed downstream from the internal tray 22 in the conveyance direction. The lower pressure plate 33 supports, from below, the sheet P or the sheet bundle Pb placed on the internal tray 22. The lower pressure plate 33 is disposed on a lower-pressure-plate holder 331. The upper pressure plate 34 can move (up and down) in the thickness direction of the sheet P above the sheet P or the sheet bundle Pb placed on the internal tray 22. In other words, the lower pressure plate 33 and the upper pressure plate 34 are disposed to face each other in the thickness direction of the sheet P or the sheet bundle Pb with the sheet P or the sheet bundle Pb placed on the internal tray 22 and interposed between the lower pressure plate 33 and the upper pressure plate 34. In the following description, the thickness direction of the sheet P or the sheet bundle Pb may be referred to simply as “thickness direction.” Further, the upper pressure plate 34 has a through hole 34a penetrating in the thickness direction at a position facing the liquid application member 451 (one end portion of a liquid supply member 45 (liquid absorber) to be described later, which corresponds to a tip portion) held via a joint 46 attached to a base plate 40.

The liquid-applier movement assembly 35 moves the upper pressure plate 34, the base plate 40, and the liquid application member 451 in the thickness direction of the sheet P or the sheet bundle Pb. The liquid-applier movement assembly 35 according to the present embodiment moves the upper pressure plate 34, the base plate 40, and the liquid application member 451 in conjunction with each other with a single liquid-applier movement motor 37. The liquid-applier movement assembly 35 includes, for example, a liquid-applier movement motor 37, a trapezoidal screw 38, a nut 39, the base plate 40, columns 41a and 41b, and coil springs 42a and 42b.

The liquid-applier movement motor 37 generates driving force to move the upper pressure plate 34, the base plate 40, the joint 46, and the liquid application member 451. The trapezoidal screw 38 extends in the thickness direction of the sheet P or the sheet bundle Pb and is attached to the liquid application frame 31a such that the trapezoidal screw 38 is rotatable in the forward and reverse directions. The trapezoidal screw 38 is coupled to an output shaft of the liquid-applier movement motor 37 via, for example, a pulley and a belt. The nut 39 is screwed to the trapezoidal screw 38. The trapezoidal screw 38 is rotated in the forward and reverse directions by the driving force transmitted from the liquid-applier movement motor 37. The rotation of the trapezoidal screw 38 causes the nut 39 to reciprocate on the trapezoidal screw 38.

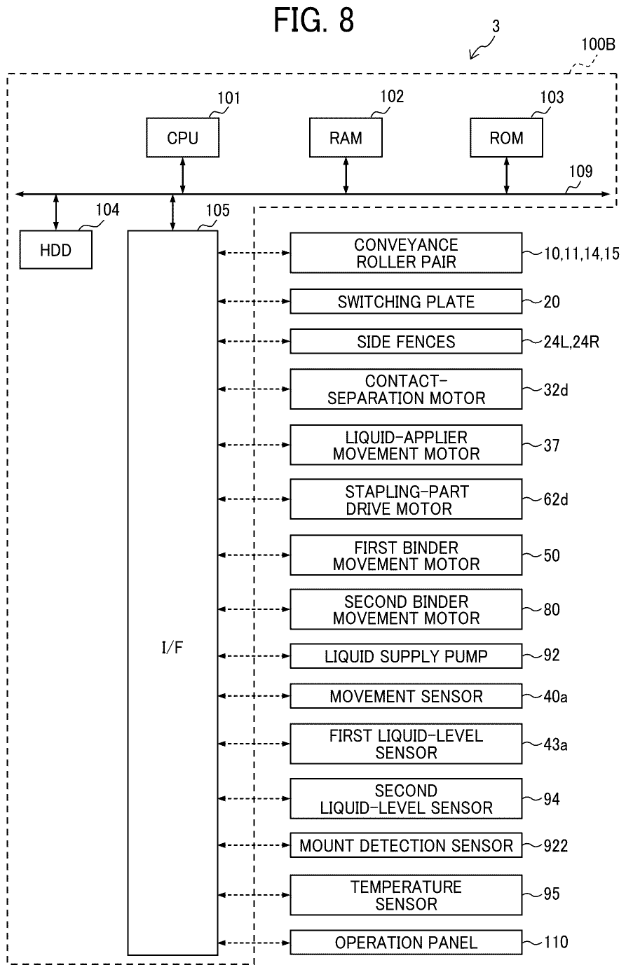

The base plate 40 is disposed above the upper pressure plate 34. The base plate 40 holds the liquid application member 451 with the tip portion of the liquid application member 451 protruding from the base plate 40 toward the upper pressure plate 34. The base plate 40 is coupled to the trapezoidal screw 38 via the nut 39 such that base plate 40 can reciprocate along the trapezoidal screw 38 as the trapezoidal screw 38 rotates in the forward and reverse directions. The position of the base plate 40 in the vertical direction is detected by a movement sensor 40a (see FIG. 8).

The columns 41a and 41b project from the base plate 40 toward the upper pressure plate 34 around the end of the liquid application member 451. The columns 41a and 41b can relatively move with respect to the base plate 40 in the thickness direction. The columns 41a and 41b hold the upper pressure plate 34 with the respective ends closer to the lower pressure plate 33 than the other ends of the columns 41a and 41. The other ends of the columns 41a and 41 opposite the ends closer to the lower pressure plate 33 are provided with stoppers that prevent the columns 41a and 41b from being removed from the base plate 40. The coil springs 42a and 42b are fitted around the columns 41a and 41b, respectively, between the base plate 40 and the upper pressure plate 34. The coil springs 42a and 42b bias the upper pressure plate 34 and the columns 41a and 41b toward the lower pressure plate 33 with respect to the base plate 40.

The liquid application assembly 36 applies liquid to the sheet P or the sheet bundle Pb placed on the internal tray 22. Specifically, the liquid application assembly 36 brings the liquid application member 451 into contact with the sheet P or the sheet bundle Pb to apply the liquid to at least one sheet P of the sheet bundle Pb. The liquid application assembly 36 includes the first liquid storage tank 43, the liquid supply member 45 including the liquid application member 451, and the joint 46.

The first liquid storage tank 43 stores the liquid to be supplied to the sheet P or the sheet bundle Pb. The liquid stored in the first liquid storage tank 43 is detected by a first liquid-level sensor 43a serving as a first liquid detector.

The liquid supply member 45 serving as a liquid absorber has one end portion as the liquid application member 451 and the other end portion as a liquid immersion portion 452. The liquid immersion portion 452 is immersed in the liquid stored in the first liquid storage tank 43 and draws up the liquid to supply the liquid to the liquid application member 451. The liquid application member 451 is made of a material (e.g., sponge or fiber) having a high liquid absorption rate, such as an elastic resin formed of open cells.

The liquid supply member 45 is made of a material having a high liquid absorption rate, for example, similarly to the liquid application member 451. As a result, the liquid absorbed from the liquid immersion portion 452 of the liquid supply member 45 is supplied to the liquid application member 451 by the capillary phenomenon. In other words, the liquid immersion portion 452 has a configuration of drawing up the liquid stored in the first liquid storage tank 43 and supplying the liquid to the liquid application member 451, which is connected to the tip end of the liquid immersion portion 452 through the liquid supply member 45.

The liquid drawn up from the liquid immersion portion 452 is supplied to the liquid application member 451 through the liquid supply member 45, and the liquid application member 451 comes into contact with the uppermost surface of the sheets P or the sheet bundle Pb to apply the liquid. For this reason, the liquid application member 451 is supported by the base plate 40 with the tip end of the liquid application member 451 facing downward.

Although the case where the liquid supply member 45 and the liquid application member 451 are separate bodies has been described above, the liquid supply member 45 and the liquid application member 451 may be a unified body formed of a material having a high liquid absorption rate. In other words, the liquid application member 451 may be part of the liquid supply member 45. In such a case, liquid can be supplied from the liquid supply member 45 to the liquid application member 451 more smoothly by the capillary phenomenon.

A protector 45a is an elongated cylindrical body (e.g., a tube) that is fitted around the liquid supply member 45. Accordingly, the protector 45a prevents the liquid absorbed by the liquid supply member 45 from leaking or evaporating. Each of the liquid supply member 45 and the protector 45a is made of a flexible material. The joint 46 fixes the liquid application member 451 to the base plate 40. Accordingly, the liquid application member 451 keeps projecting downward from the base plate 40 with the end of the liquid application member 451 facing downward, even when the liquid application member 451 is moved by the liquid-applier movement assembly 35.

A description is given below of the configuration of the crimper 32.

The crimper 32 serving as a post-processing device presses and deforms a portion of the sheet bundle Pb with serrate upper crimping teeth 32a and lower crimping teeth 32b, and crimps sheets P at the portion to bind the sheet bundle Pb. In other words, the crimper 32 binds the sheet bundle Pb without staples. The components of the crimper 32 such as the upper crimping teeth 32a and the lower crimping teeth 32b are disposed on a crimping frame 32c. In the following description, such a way of pressing and deforming a given position on the sheet bundle Pb to bind the sheet bundle Pb may be referred to as “crimping.” In other words, the crimper 32 crimps the sheet bundle Pb or performs crimping on the sheet bundle Pb. The crimping operation of the crimper 32 that involves control processing is referred to as “crimping process”.

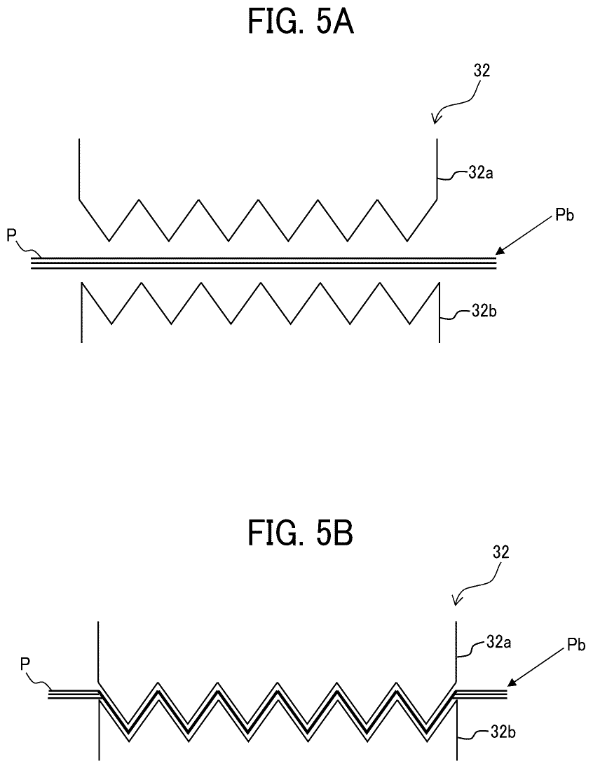

FIGS. 5A and 5B are schematic diagrams illustrating the configuration of the crimper 32. As illustrated in FIGS. 5A and 5B, the crimper 32 includes the upper crimping teeth 32a and the lower crimping teeth 32b. The upper crimping teeth 32a and the lower crimping teeth 32b are disposed to face each other in the thickness direction of the sheet bundle Pb to pinch the sheet bundle Pb placed on the internal tray 22. The upper crimping teeth 32a and the lower crimping teeth 32b have respective serrate faces facing each other. The serrate face of each of the upper crimping teeth 32a and the lower crimping teeth 32b includes concave portions and convex portions alternately formed. The concave portions and the convex portions of the upper crimping teeth 32a are shifted from those of the lower crimping teeth 32b such that the upper crimping teeth 32a are engaged with the lower crimping teeth 32b. The upper crimping teeth 32a and the lower crimping teeth 32b are brought into contact with and separated from each other by the driving force of a contact-separation motor 32d illustrated in FIG. 8.

In the process of supplying the sheets P of the sheet bundle Pb to the internal tray 22, the upper crimping teeth 32a and the lower crimping teeth 32b are separated from each other as illustrated in FIG. 5A. When all the sheets P of the sheet bundle Pb are placed on the internal tray 22, the upper crimping teeth 32a and the lower crimping teeth 32b are engaged with each other as illustrated in FIG. 5B by the driving force of the contact-separation motor 32d to press and deform the sheet bundle Pb in the thickness direction. As a result, the sheet bundle Pb that has been placed on the internal tray 22 is crimped. The sheet bundle Pb thus crimped is ejected to the output tray 26 by the conveyance roller pair 15.

The configuration of the crimper 32 as a crimping assembly is not limited to the configuration of a moving assembly exemplified in the present embodiment, and may be any other suitable structure in which the upper crimping teeth 32a and the lower crimping teeth 32b of the crimping assembly engage with each other. For example, the crimping assembly may bring the upper crimping teeth 32a and the lower crimping teeth 32b into contact with each other and separate the upper crimping teeth 32a and the lower crimping teeth 32b from each other with a link mechanism and a driving source that simply rotates forward or that rotates forward and backward (e.g., the crimping assembly disclosed in Japanese Patent No. 6057167). Alternatively, the crimping assembly may employ a linear motion system to linearly bring the upper crimping teeth 32a and the lower crimping teeth 32b into contact with each other and separate the upper crimping teeth 32a and the lower crimping teeth 32b from each other with a screw assembly that converts the forward and backward rotational motions of a driving source into linear reciprocating motion.

As illustrated in FIG. 3, the edge binder 25 includes a first movement assembly 47. The first movement assembly 47 moves the edge binder 25 (i.e., the liquid applier 31 and the crimper 32) in the main scanning direction along the downstream end of the sheet P, which is placed on the internal tray 22, in the conveyance direction. The first movement assembly 47 includes, for example, the base 48, a guide shaft 49, the first binder movement motor 50, and a driving force transmission assembly 51.

The liquid applier 31 and the crimper 32 are attached to the base 48 with the liquid applier 31 and the crimper 32 being adjacent to each other in the main scanning direction. The guide shaft 49 extends in the main scanning direction at a position downstream from the internal tray 22 in the conveyance direction. The guide shaft 49 supports the base 48 such that the base 48 can move in the main scanning direction. The first binder movement motor 50 generates a driving force for moving the edge binder 25.

The driving force transmission assembly 51 transmits the driving force of the first binder movement motor 50 to the base 48 via a pulley and a timing belt. As a result, the liquid applier 31 and the crimper 32 integrated by the base 48 move in the main scanning direction along the guide shaft 49. The position of the edge binder 25 may be ascertained with, for example, an encoder sensor attached to an output shaft of the first binder movement motor 50.

In the above description, the edge binder 25 has a configuration of moving along the guide shaft 49 with the crimper 32 and the liquid applier 31 being integrated, embodiments of the present disclosure are not limited to the above-described configuration. For example, the crimper 32 and the liquid applier 31 may have a configuration of moving independently of each other.

A description is given of the staple binder 55.

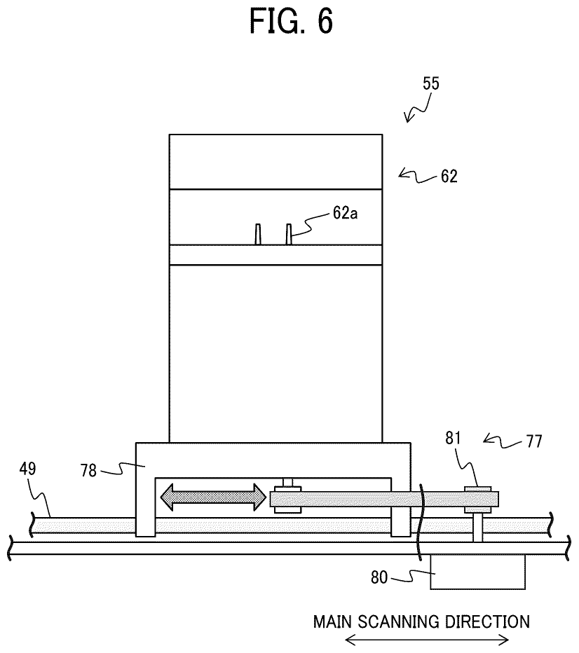

Details of the staple binder 55 having the function of executing the stapling process are described below. FIG. 6 is a schematic view of the staple binder 55 as viewed from the upstream side in the conveyance direction. The staple binder 55 includes a stapler 62 that binds a sheet bundle Pb with staples. The stapler 62 is disposed downstream from the internal tray 22 in the conveyance direction and spaced apart from the edge binder 25 in the main scanning direction.

The stapler 62 serving as a post-processing device has a configuration of performing so-called “stapling” (i.e., stapling process) to bind a sheet bundle Pb with a staple or staples. More specifically, the stapler 62 includes a stapling-part drive motor 62d illustrated in FIG. 8. The stapling-part drive motor 62d drives a stapling part 62a. The driving force of the stapling-part drive motor 62d causes a staple loaded in the stapling part 62a to penetrate through a sheet bundle Pb, so that the stapling part 62a binds the sheet bundle Pb. Since the stapler 62 has a typical configuration, a detailed description thereof will be omitted unless otherwise required.

As illustrated in FIG. 6, the staple binder 55 includes a second movement assembly 77. The second movement assembly 77 moves the staple binder 55 in the main scanning direction along a downstream end of the sheet P or the sheet bundle Pb placed on the internal tray 22 in the conveyance direction of the sheet P or the sheet bundle Pb. The second movement assembly 77 includes, for example, a base 78, a guide shaft 49, a second binder movement motor 80, and a driving force transmission assembly 81. Since the configuration of the second movement assembly 77 is common to that of the first movement assembly 47, the description thereof is omitted.

The edge binder 25 and the staple binder 55 are supported by the common guide shaft 49. In other words, the first movement assembly 47 and the second movement assembly 77 move the edge binder 25 and the staple binder 55 in the main scanning direction along the common guide shaft 49. The first movement assembly 47 and the second movement assembly 77 can move the edge binder 25 and the staple binder 55 independently of each other.

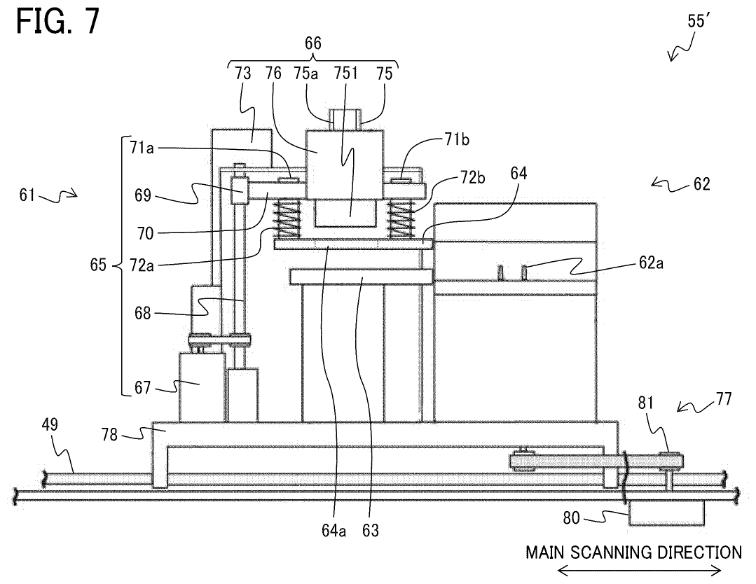

FIG. 7 illustrates a staple binder 55′as a modification of the staple binder 55. More specifically, FIG. 7 is a schematic view of the staple binder 55′as viewed from the upstream side in the conveyance direction. The staple binder 55′is different from the staple binder 55 in that the staple binder 55′includes a second liquid applier 61 in addition to the stapler 62. As illustrated in FIG. 7, the staple binder 55′includes the second liquid applier 61 and the stapler 62. The second liquid applier 61 and the stapler 62 are disposed downstream from the internal tray 22 in the conveyance direction and adjacent to each other in the main scanning direction.

The second liquid applier 61 executes “liquid application” of applying liquid stored in a third liquid storage tank 73 to the sheet P or the sheet bundle Pb supported on the internal tray 22. A given area including a position to which the liquid is applied on the sheet P or the sheet bundle Pb by the second liquid applier 61 corresponds to a binding position to be stapled. As illustrated in FIG. 7, the second liquid applier 61 includes a second lower pressure plate 63, a second upper pressure plate 64, a second liquid-applier movement assembly 65, and a second liquid application assembly 66. The second liquid-applier movement assembly 65 includes, for example, a second liquid-applier movement motor 67, a second trapezoidal screw 68, a second nut 69, a second base plate 70, second columns 71a and 71b, and second coil springs 72a and 72b. The second liquid application assembly 66 includes the third liquid storage tank 73, a second liquid supply member 75, a second liquid application member 751, and a second joint 76. Since the second liquid application assembly 66 and the liquid application assembly 36 have common configurations, redundant descriptions thereof are omitted below unless otherwise required. Since the configuration of the stapler 62 illustrated in FIG. 7 is like the configuration of the stapler 62 illustrated in FIG. 6, a detailed description thereof is omitted below unless otherwise required.

In the binding process, the staple binder 55′illustrated in FIG. 7 performs a liquid application process on a sheet P to loosen and soften the binding position of the sheet P, allowing a staple to easily pass through the sheet bundle Pb. As a result, the number of sheets to be bound per sheet bundle Pb can be increased as compared with a case where the stapling process is performed without applying the liquid.

As illustrated in FIG. 2, the post-processing apparatus 3 further includes an end fence 27, a saddle binder 28, a sheet folding blade 29, and the output tray 30. The end fence 27, the saddle binder 28, and the sheet folding blade 29 perform saddle binding on a sheet bundle Pb foamed of the sheets P that are conveyed through the third conveyance passage Ph3. Among the sheets P supplied from the image forming apparatus 2, the sheet bundle Pb subjected to the saddle binding is ejected to the output tray 30.

The end fence 27 aligns the positions of the sheets P that are sequentially conveyed through the third conveyance passage Ph3, in a direction in which the sheets P are conveyed. The end fence 27 can move between a binding position where the end fence 27 causes the center of the sheet bundle Pb to face the saddle binder 28 and a folding position where the end fence 27 causes the center of the sheet bundle Pb to face the sheet folding blade 29. The saddle binder 28 binds the center of the sheet bundle Pb aligned by the end fence 27 at the binding position. The sheet folding blade 29 folds, in half, the sheet bundle Pb placed on the end fence 27 at the folding position and causes the conveyance roller pair 18 to nip the sheet bundle Pb. The conveyance roller pairs 18 and 19 eject the sheet bundle Pb subjected to the saddle binding to the output tray 30.

A description is given below of a control block of the post-processing apparatus 3.

A description is given below of a control block of the post-processing apparatus 3, with reference to FIG. 8. FIG. 8 illustrates a hardware configuration for executing control processing executed in the post-processing apparatus 3. As illustrated in FIG. 8, the post-processing apparatus 3 includes a central processing unit (CPU) 101, a random-access memory (RAM) 102, a read-only memory (ROM) 103, a hard disk drive (HDD) 104, and an interface (I/F) 105. The CPU 101, the RAM 102, the ROM 103, the HDD 104, and the I/F 105 are connected to each other via a common bus 109.

The CPU 101 is an arithmetic unit and controls the overall operation of the post-processing apparatus 3. The RAM 102 is a volatile storage medium that allows data to be read and written at high speed. The CPU 101 uses the RAM 102 as a working area for data processing. The ROM 103 is a read-only non-volatile storage medium that stores programs such as firmware. The HDD 104 is a non-volatile storage medium that allows data to be read and written and has a relatively large storage capacity. The HDD 104 stores, for example, an operating system (OS), various control programs, and application programs.

By an arithmetic function of the CPU 101, the post-processing apparatus 3 processes, for example, a control program stored in the ROM 103 and an information processing program (application program) loaded into the RAM 102 from a storage medium such as the HDD 104. Such processing configures a software controller including various functional modules of the post-processing apparatus 3. The software controller thus configured cooperates with hardware resources of the post-processing apparatus 3 to construct functional blocks that implement functions of the post-processing apparatus 3. In other words, the CPU101, the RAM 102, the ROM 103, the HDD 104, and the I/F 105 constitute at least part of a controller 100B serving as a control device that controls the operation of the post-processing apparatus 3.

The I/F 105 is an interface that connects the conveyance roller pairs 10, 11, 14, and 15, the switching plate 20, the side fences 24L and 24R, the contact-separation motor 32d, the liquid-applier movement motor 37, the stapling-part drive motor 62d, the first binder movement motor 50, the second binder movement motor 80, a liquid supply pump 92, the movement sensor 40a, the first liquid-level sensor 43a, a second liquid-level sensor 94, a mount detection sensor 922, a temperature sensor 95, and an operation panel 110 to the common bus 109. The controller 100B operates, via the I/F 105, the conveyance roller pairs 10, 11, 14, and 15, the switching plate 20, the side fences 24L and 24R, the contact-separation motor 32d, the liquid-applier movement motor 37, the stapling-part drive motor 62d, the first binder movement motor 50, the second binder movement motor 80, and the liquid supply pump 92. The controller 100B acquires the detection results from the movement sensor 40a, the first liquid-level sensor 43a, the second liquid-level sensor 94, the mount detection sensor 922, and the temperature sensor 95. Although FIG. 8 illustrates only the components related to the edge binder 25 and the staple binder 55 that perform the edge binding, the components related to the saddle binder 28 that performs the saddle binding are also controlled by the controller 100B.

As illustrated in FIG. 1, the image forming apparatus 2 includes the operation panel 110. The operation panel 110 includes an operation device that receives instructions from a user and a display serving as a notifier that notifies the user of information. The operation device includes, for example, hard keys and a touch screen overlaid on the display. The operation panel 110 acquires information from the user through the operation device and provides information to the user through the display. The specific example of the notifier is not limited to the display and may be, for example, a light emitting diode (LED) lamp or a speaker. The post-processing apparatus 3 may include an operation panel 110 similar to the above-described operation panel 110 of the image forming apparatus 2.

As described above, the post-processing apparatus 3 implements the function of performing operation control related to the liquid application by software (control programs) executed by the CPU 101 with hardware resources included in the controller 100B.

In some embodiments, the liquid application performed by the post-processing apparatus 3 may be performed in a form in which the staple binder 55 is provided with only the stapler 62 and the liquid application is performed using the liquid applier 31 of the edge binder 25. Alternatively, on the contrary, the edge binder 25 may be provided with only the crimper 32, and the liquid application may be performed using the second liquid applier 61 of the staple binder 55. In other words, the post-processing apparatus 3 may have a configuration in which only one of the liquid applier 31 and the second liquid applier 61 performs the liquid application, regardless of the type of the binding process.

Further, in the above description, the staple binder 55′has a configuration of moving along the guide shaft 49 with the stapler 62 and the second liquid applier 61 being integrated. However, embodiments of the present disclosure are not limited to the above-described configuration. For example, the stapler 62 and the second liquid applier 61 may have a configuration of moving independently of each other.

A description is given below of the binding process.

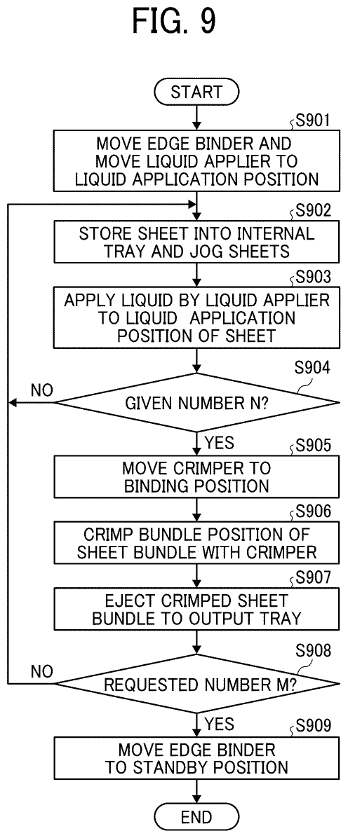

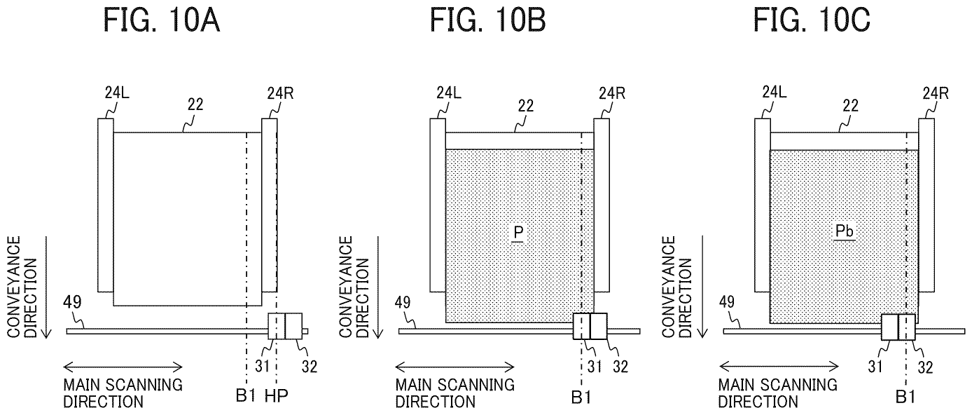

Specifically, a description is given below of the binding process executed by the edge binder 25 included in the post-processing apparatus 3. FIG. 9 is a flowchart of the binding process. FIGS. 10A, 10B, and 10C are diagrams illustrating the positions of the liquid applier 31 and the crimper 32 during the binding process of FIG. 9. FIGS. 10A, 10B, and 10C do not illustrate changes in the postures of the liquid applier 31 and the crimper 32. The liquid application position to which liquid is applied on a sheet P or a sheet bundle Pb by the liquid applier 31 corresponds to the binding position on the sheet bundle Pb to be crimped by the crimper 32. For this reason, in the following description, the liquid application position and the binding position are denoted by the same reference sign.

For example, the controller 100B starts the binding process illustrated in FIG. 9 when the controller 100 acquires an instruction to execute the binding process from the image forming apparatus 2. In the following description, the instruction to execute the binding process may be referred to as a “binding command.”

The binding command includes, for example, the type of the sheet P (i.e., information affecting the spread of liquid, such as material and thickness), the number of sheets P of the sheet bundle Pb, the number of sheet bundles Pb to be bound, the binding position on the sheet bundle Pb, and the binding posture of the edge binder 25. In the following description, the number of sheets P of the sheet bundle Pb may be referred to as “given number N” whereas the number of sheet bundles Pb to be bound may be referred to as “requested number M of copies.” The liquid applier 31 and the crimper 32 are assumed to be in a parallel binding posture and located at a standby position HP (FIG. 10A) that is a position shifted in the width direction from the sheets P placed on the internal tray 22 at the start of the binding process.

In step S901, the controller 100B drives the first binder movement motor 50 to move the edge binder 25 in the main scanning direction such that the liquid applier 31 faces a liquid application position B1 instructed by the binding command. The controller 100B executes the operation of step S901 before a first sheet P is conveyed to the internal tray 22 by the conveyance roller pairs 10, 11, 14, and 15.

In step S902, the controller 100B rotates the conveyance roller pairs 10, 11, 14, and 15 to store the sheet P, on which the image has been formed by the image forming apparatus 2, onto the internal tray 22. In step S902, the controller 100B moves the side fences 24L and 24R to align the position of the sheets P, which are placed on the internal tray 22, in the main scanning direction. This alignment of the position of a sheet bundle is also referred to as jogging.

In step S903, the controller 100B causes the liquid applier 31 facing the liquid application position B1 to apply liquid to the liquid application position B1 of the sheet P placed on the internal tray 22 in the immediately preceding step S902, based on the liquid application control data adjusted in advance. In other words, the controller 100B drives the liquid-applier movement motor 37 to bring the liquid application member 451 into contact with the liquid application position B1 on the sheet P placed on the internal tray 22 (see FIG. 10B). In the liquid application process in step S903, the controller 100B adjusts the position at which the liquid application member 451 applies liquid to the sheet P in accordance with the type of the sheet P and the binding position included in the binding command. The controller 100B adjusts the amount of pressing the liquid application member 451 against the sheet P. In other words, the controller 100B controls the driving of the liquid-applier movement motor 37 based on the adjusted control data, and adjusts the amount of movement of the liquid application member 451 with respect to the liquid application position B1 of the sheet P placed on the internal tray 22 (see FIG. 10B).

In step S904, the controller 100B determines whether the number of sheets P placed on the internal tray 22 has reached the given number N instructed by the binding command. When the controller 100B determines that the number of sheets P placed on the internal tray 22 has not reached the given number N (NO in step S904), the controller 100B executes the operations of steps S902 and S903 again. In other words, the controller 100B executes the operations of steps S902 and S903 each time a sheet P is conveyed to the internal tray 22 by the conveyance roller pairs 10, 11, 14, and 15. The liquid application of the liquid applier 31 may be performed on all or some of the sheets P of the sheet bundle Pb.

When the controller 100B determines that the number of sheets P placed on the internal tray 22 has reached the given number N (YES in step S904), in step S905, the controller 100B drives the first binder movement motor 50 to move the edge binder 25 in the main scanning direction such that the crimper 32 faces the binding position B1 as illustrated in FIG. 10C.

In step S906, the controller 100B causes the crimper 32 to crimp the sheet bundle Pb placed on the internal tray 22. In step S907, the controller 100B causes the conveyance roller pair 15 to eject the sheet bundle Pb thus crimped by the crimper 32 to the output tray 26. Specifically, the controller 100B drives the contact-separation motor 32d to cause the upper crimping teeth 32a and the lower crimping teeth 32b to pinch the binding position B1 on the sheet bundle Pb placed on the internal tray 22. The sheet bundle Pb is pressed and deformed between the upper crimping teeth 32a and the lower crimping teeth 32b. Thus, the crimper 32 crimps the sheet bundle Pb. Then, the controller 100B rotates the conveyance roller pair 15 to eject the sheet bundle Pb thus crimped to the output tray 26.

The sheet bundle Pb placed on the internal tray 22 has a crimping area (corresponding to the binding position B1) pinched between the upper crimping teeth 32a and the lower crimping teeth 32b in step S906. The crimping area overlaps a liquid application area (corresponding to the liquid application position B1) contacted by a distal end of the liquid application member 451 in step S903. In other words, the crimper 32 crimps an area to which liquid is applied by the liquid applier 31 on the sheet bundle Pb placed on the internal tray 22. The crimping area that is pinched by the upper crimping teeth 32a and the lower crimping teeth 32b may completely or partially overlaps the liquid application area contacted by the distal end of the liquid application member 451, to obtain a sufficient binding strength.

In step S908, the controller 100B determines whether the number of sheet bundles Pb thus ejected has reached the requested number M of copies indicated by the binding command. When the controller 100B determines that the number of sheet bundles Pb thus ejected has not reached the requested number M of copies (NO in step S908), the controller 100B executes the operations of step S902 and the following steps again. In other words, when the controller 100B determines that the number of sheet bundles Pb thus ejected has not reached the requested number M of copies (NO in step S908), the controller 100B repeats the operations of steps S902 to S907 until the number of sheet bundles Pb ejected to the output tray 26 reaches the requested number M of copies.

When the controller 100B determines that the number of sheet bundles Pb ejected to the output tray 26 has reached the requested number M of copies (YES in step S908), in step S909, the controller 100B drives the first binder movement motor 50 to move the edge binder 25 to the standby position HP as illustrated in FIG. 10A. As a result, the liquid applier 31 and the crimper 32 return to the standby position HP position illustrated in FIG. 10A.

A description is given of a first embodiment of the present disclosure.

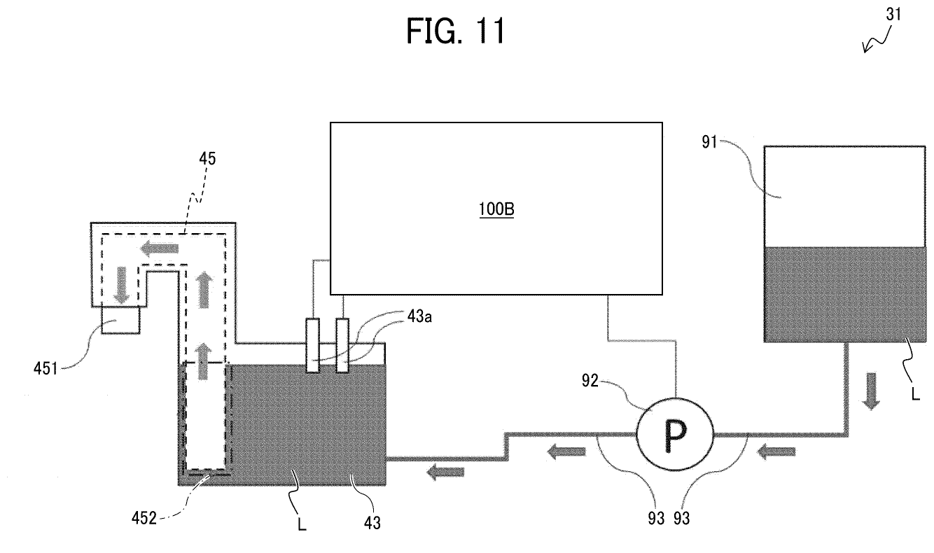

Specifically, a medium processing apparatus according to a first embodiment of the present disclosure is described in more detail. FIG. 11 is a diagram illustrating a liquid applier 31 according to the present embodiment. The liquid applier 31 includes a liquid supply member 45 having a liquid application member 451 and a liquid immersion portion 452, a first liquid storage tank 43 as a first liquid storage, a second liquid storage tank 91 as a second liquid storage, a liquid supply pump 92 and a liquid supply passage 93 as a liquid supplier, and a controller 100B as a control device.

As described above, the liquid supply member 45 is formed of a liquid absorber that has a portion (the liquid immersion portion 452) to be immersed in the liquid stored in the first liquid storage tank 43 and another portion (the liquid application member 451) to come into contact with a sheet P or a sheet bundle Pb to apply the liquid to the sheet P or the sheet bundle Pb.

The second liquid storage tank 91 stores liquid to be supplied to the first liquid storage tank 43. The liquid stored in the second liquid storage tank 91 is supplied to the first liquid storage tank 43 through the liquid supply passage 93 by the operation of the liquid supply pump 92.

The first liquid storage tank 43 includes the first liquid-level sensor 43a as a first liquid detector for detecting the presence or absence of liquid (i.e., the amount of liquid stored) in the first liquid storage tank 43. The first liquid-level sensor 43a is an electrode sensor having a pair of electrodes.

The output value (voltage) output when the first liquid-level sensor 43a detects the liquid (liquid level) in the first liquid storage tank 43 is input to the controller 100B as a control device. The controller 100B determines the presence or absence of liquid (the amount of liquid stored) in the first liquid storage tank 43 based on whether the output value, which is input from the first liquid-level sensor 43a, exceeds the “liquid detection threshold value” (threshold value). If the controller 100B determines that the liquid is to be replenished, the controller 100B operates the liquid supply pump 92 to supply the liquid from the second liquid storage tank 91 to the first liquid storage tank 43.

The controller 100B controls the timing of application of the voltage to the electrodes of the first liquid-level sensor 43a. The controller 100B also controls the start and stop of the operation of the liquid supply pump 92 in accordance with the output value of the first liquid-level sensor 43a. When the first liquid-level sensor 43a detects the liquid (liquid level) in the first liquid storage tank 43 by the operation of the liquid supply pump 92 according to the output value of the first liquid-level sensor 43a, the controller 100B stops the operation of the liquid supply pump 92 and also stops the voltage application to the first liquid-level sensor 43a.

The controller 100B measures the elapsed time after the operation of the liquid supply pump 92 is stopped. When the elapsed time exceeds a first predetermined time, the controller 100B energizes (i.e., applies a voltage to) the electrodes of the first liquid-level sensor 43a and performs the detection process of detecting the liquid (liquid level) in the first liquid storage tank 43 again.

It takes time for the liquid stored in the first liquid storage tank 4 to be drawn up by the capillary phenomenon of the liquid supply member 45 and sent from the liquid immersion portion 452 to the liquid application member 451 through the liquid supply member 45. For this reason, the controller 100B detects the liquid (liquid level) in the first liquid storage tank 43 after waiting for the predetermined time to elapse as described above. At this time, if the liquid supply member 45 draws up the liquid, the amount (liquid level) of liquid stored in the first liquid storage tank 4 decreases, and the first liquid-level sensor 43a does not detect the liquid (liquid level) in the first liquid storage tank 43, the controller 100B again operates the liquid supply pump 92 to supply the liquid from the second liquid storage tank 91 to the first liquid storage tank 43.

The output value of the first liquid-level sensor 43a corresponds to an electrical signal that changes according to the amount of contact of the electrodes with the liquid in the first liquid storage tank 43. Examples of the electrical signal include, but not limited to, a signal indicating an electrical resistance value, a signal indicating a voltage value, and a signal indicating a current value. In other words, the “electrical signal” may be any signal indicating an electrical value that changes when a current passes between the electrodes (when a voltage is applied) depending on whether the pair of electrodes of the electrode sensor is immersed in the liquid.

The electrode sensor is described as an example of the first liquid-level sensor 43a in the present embodiment. However, embodiments of the present disclosure are not limited to the electrode sensor, and any other method may be used. For example, a float sensor or a capacitance sensor may be used to detect the presence or absence of the liquid. Further, the first liquid-level sensor 43a is not limited to a sensor that detects the liquid level of the liquid in the first liquid storage tank 43, and may be any sensor that can detect the presence or absence of the liquid in the first liquid storage tank 43 (the amount of the liquid stored).

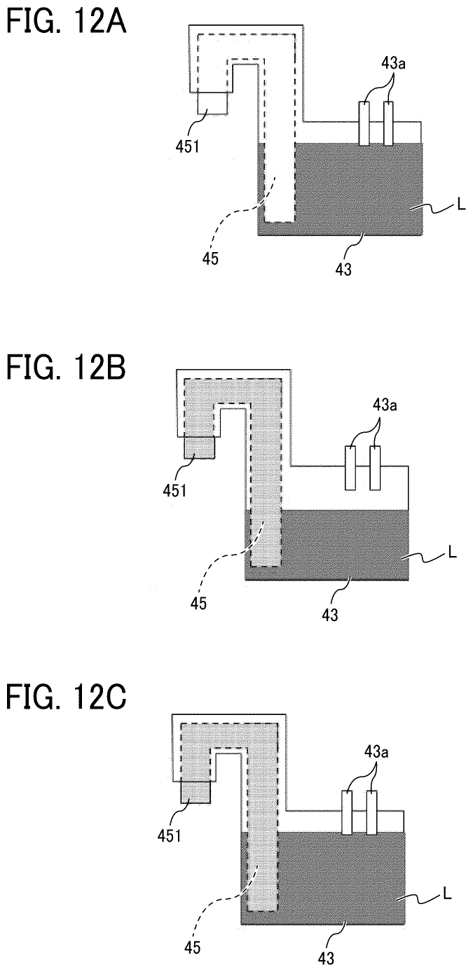

FIGS. 12A, 12B, and 12C are diagrams illustrating a change in the amount (liquid level) of the liquid stored in the first liquid storage tank 43 when the liquid supply member 45 is dry. A change in the amount (liquid level) of the liquid stored in the first liquid storage tank 43 is referred to as a “liquid level change” below.

First, as illustrated in FIG. 12A, liquid is supplied from the second liquid storage tank 91 to the first liquid storage tank 43, and the first liquid-level sensor 43a is set to detect the liquid (liquid level) in the first liquid storage tank 43. At this time, the liquid supply member 45 including the liquid immersion portion 452 is dry. The liquid level (the amount of liquid stored in the first liquid storage tank 43) at the time when the first liquid-level sensor 43a detects the liquid in the first liquid storage tank 43 is referred to as a “reference liquid level”. Then, as illustrated in FIG. 12B, the liquid is sucked up from the liquid immersion portion 452 by the capillary phenomenon, and the liquid supply member 45 is moistened with the sucked liquid. At this time, the amount (liquid level) of liquid stored in the first liquid storage tank 43 is lowered from the reference liquid level. At the stage when the liquid level is lowered, that is, at the stage when the liquid supply member 45 is moistened by sucking the liquid, the controller 100B determines the output value from the first liquid-level sensor 43a again. At this stage, when the controller 100B determines that the amount (liquid level) of liquid stored in the first liquid storage tank 43 is less than the reference liquid level, the controller 100B operates the liquid supply pump 92 to supply the liquid from the second liquid storage tank 91 to the first liquid storage tank 43 again.

In the case where an electrode sensor is used as the first liquid-level sensor 43a, there is a concern that the metal used for the electrodes might be corroded due to electrolytic corrosion if the pair of electrodes is energized (applied with electricity) constantly. Further, since the voltage is always applied to the liquid stored in the first liquid storage tank 43, there is a concern that the liquid might be electrolyzed or that the electrodes might be dissolved due to adhesion of foreign matter to the surface of the electrodes by electrolysis, which might induce deterioration of the electrodes. For this reason, the controller 100B controls the timing of the energization of the first liquid-level sensor 43a such that the first liquid-level sensor 43a is not energized all the time but is energized only when the determination process of the change in the amount of liquid stored in the first liquid storage tank 43 is executed.

A description is given below of the liquid supply determination process.

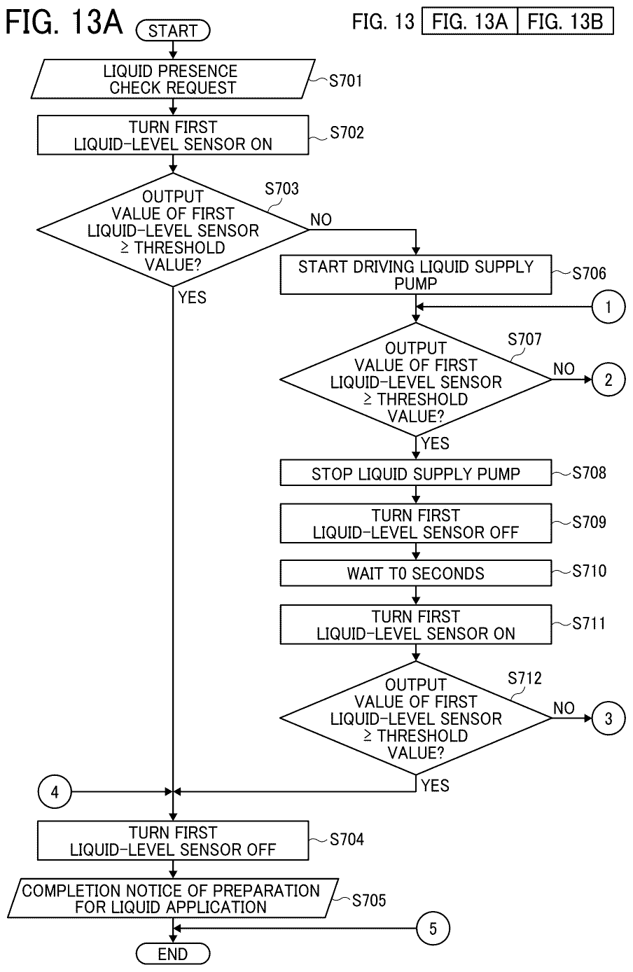

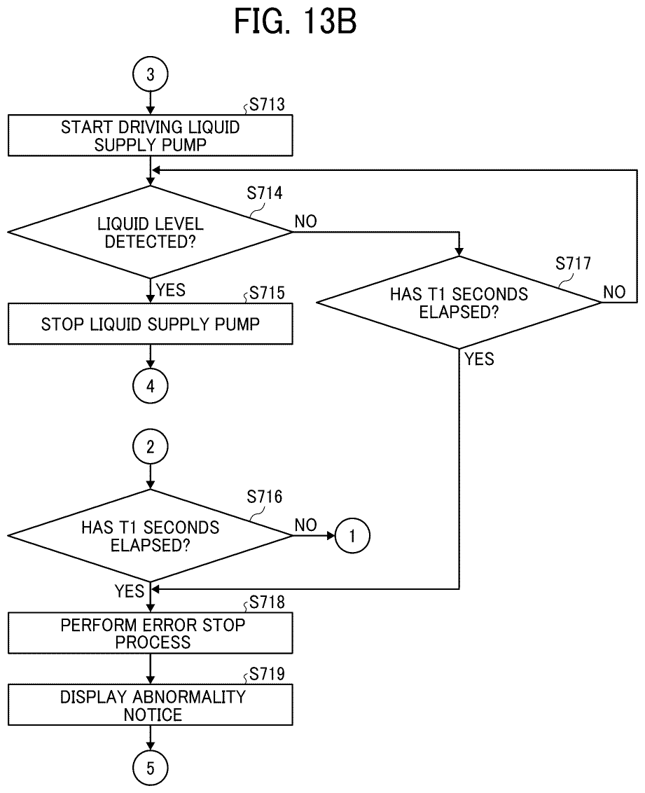

FIG. 13 including FIGS. 13A and 13B is a flowchart of the liquid supply determination process executed in the controller 100B. The liquid supply determination process according to the present embodiment is executed at the time of starting the post-processing apparatus 3 or at the time of starting the crimping process.

For example, when the post-processing apparatus 3 is activated, the liquid supply determination process is started, and a liquid presence check request is instructed to the controller 100B in step S701. The liquid presence check request may be instructed based on information input by the user from the operation panel 110 of one or both of the image forming apparatus 2 and the post-processing apparatus 3. Following the liquid presence check request, in step S702, the controller 100B applies a voltage to the first liquid-level sensor 43a (i.e., turns the first liquid-level sensor 43a on).

In step S703, the controller 100B acquires a value of an electrical signal (referred to as an “output value”) output when the first liquid-level sensor 43a detects the liquid in the first liquid storage tank 43, and determines the presence or absence of the liquid (the amount of the liquid stored) in the first liquid storage tank 43. The presence or absence of liquid is determined based on whether the output value (voltage) output from the first liquid-level sensor 43a exceeds a “liquid detection threshold value” (threshold value) set in advance. For example, when the output value (voltage) from the first liquid-level sensor 43a is equal to or greater than the liquid detection threshold value (e.g., the output voltage VTh1), the controller 100B determines that there is a sufficient amount of liquid in the first liquid storage tank 43 (YES in step S703). In this case, the controller 100B stops the application of the voltage to the first liquid-level sensor 43a (turns the first liquid-level sensor 43a off) in step S704, and displays a completion notice of the preparation for liquid application on, for example, the operation panel 110 in step S705, and ends the liquid supply determination process.

Alternatively, in step S703, when the output value (voltage) from the first liquid-level sensor 43a is less than the liquid detection threshold value (e.g., the output voltage VTh1) (NO in step S703), in step S706, the controller 100B operates the liquid supply pump 92 to supply the liquid from the second liquid storage tank 91 to the first liquid storage tank 43.

In step S707, when the output value (voltage) from the first liquid-level sensor 43a is equal to or greater than the liquid detection threshold value (e.g., the output voltage VTh1), the controller 100B determines that a sufficient amount of liquid has been supplied into the first liquid storage tank 43 (YES in S707). Alternatively, when the output value (voltage) from the first liquid-level sensor 43a is less than the liquid detection threshold value (e.g., the output voltage VTh1) (NO in step S707) and the elapsed time after the operation start of the liquid supply pump 92 (i.e., after step S706) does not exceed the abnormality determination time (T1 seconds) (NO in step S716), the liquid supply pump 92 continues to supply the liquid from the second liquid storage tank 91 to the first liquid storage tank 43 until the output value (voltage) from the first liquid-level sensor 43a becomes equal to or greater than the liquid detection threshold value (e.g., the output voltage VTh1) (YES in step S707).

If the output value (voltage) from the first liquid-level sensor 43a does not become equal to or greater than the liquid detection threshold value (e.g., the output voltage VTh1) by the time when the abnormality determination time (T1 seconds) has elapsed (NO in step S707 and YES in step S716), in step S718, the controller 100B determines that some abnormality (e.g., a failure of one of both of the liquid supply pump 92 and the first liquid-level sensor 43a) has occurred in a device, and performs an error stop process to stop the liquid supply pump 92 and/or turn off the first liquid-level sensor 43a. In step S719, the controller 100B causes the operation panel 110 to display the abnormality notice, and ends the liquid supply determination process.

If the output value (voltage) from the first liquid-level sensor 43a becomes equal to or greater than the liquid detection threshold value (e.g., the output voltage VTh1) in step S707 (YES in step S707), in step S708, the controller 100B stops the liquid supply pump 92 to stop the supply of the liquid from the second liquid storage tank 91 to the first liquid storage tank 43. In step S709, the controller 100B stops the application of the voltage to the first liquid-level sensor 43a (i.e., turns the first liquid-level sensor 43a off).

Then, in step S710, the controller 100B temporarily stops the liquid supply determination process until a standby time (first predetermined time TO), which is set in advance as a time until the liquid supply member 45 completes the sucking of the liquid, has elapsed.

After the first predetermined time TO has elapsed, the controller 100B again turns the first liquid-level sensor 43a on in step S711, and causes the first liquid-level sensor 43a to determine the presence or absence of the liquid in the first liquid storage tank 43 in step S712. At this stage, the liquid level (liquid storage amount) of the liquid in the first liquid storage tank 43 is lowered by the suction of the liquid supply member 45. However, if the output value (voltage) from the first liquid-level sensor 43a is equal to or greater than the liquid detection threshold value (e.g., the output voltage VTh1) (YES in step S712), in step S704, the controller 100B stops the application of the voltage to the first liquid-level sensor 43a (i.e., turns the first liquid-level sensor 43a off). In step S705, the controller 100B displays a completion notice of the preparation for liquid application on, for example, the operation panel 110, and ends the liquid supply determination process.

Alternatively, when the output value (voltage) from the first liquid-level sensor 43a is less than the liquid detection threshold value (e.g., the output voltage VTh1) in step S712 (NO in step S712), in step S713, the controller 100B operates the liquid supply pump 92 to supply the liquid from the second liquid storage tank 91 to the first liquid storage tank 43.

Subsequently, when the output value (voltage) from the first liquid-level sensor 43a is equal to or greater than the liquid detection threshold value (e.g., the output voltage VTh1), the controller 100B determines that a sufficient amount of liquid has been supplied into the first liquid storage tank 43 (YES in step S714). In this case, the controller 100B stops the liquid supply pump 92 to stop the supply of the liquid from the second liquid storage tank 91 to the first liquid storage tank 43 (in step S715). Then, the controller 100B stops the application of the voltage to the first liquid-level sensor 43a (turns the first liquid-level sensor 43a off) in step S704, displays a completion notice of the preparation for liquid application on, for example, the operation panel 110 (step S705), and ends the liquid supply determination process.

Alternatively, when the output value (voltage) from the first liquid-level sensor 43a is less than the liquid detection threshold value (e.g., the output voltage VTh1) (NO in step S714) and the elapsed time after the operation start of the liquid supply pump 92 (i.e., after step S713) does not exceed the abnormality determination time (T1 seconds) (NO in step S717), the liquid supply pump 92 continues to supply the liquid from the second liquid storage tank 91 to the first liquid storage tank 43 until the output value (voltage) from the first liquid-level sensor 43a becomes equal to or greater than the liquid detection threshold value (e.g., the output voltage VTh1) (YES in step S714).

If the output value from the first liquid-level sensor 43a does not become equal to or greater than the liquid detection threshold value (e.g., the output voltage VTh1) by the time when the abnormality determination time (T1 seconds) has elapsed (NO in step S714 and YES in step S717), in step S718, the controller 100B determines that some abnormality has occurred in a device, and performs an error stop process of stopping the liquid supply pump 92 and/or turning the first liquid-level sensor 43a off. In step S719, the controller 100B displays the abnormality notice on the operation panel 110, and then ends the liquid supply determination process. The “abnormality notice” may be, for example, a display of a warning on the operation panel 110 to prompt a check because there is a possibility that one or both of the liquid supply pump 92 and the first liquid-level sensor 43a are out of order. By the liquid supply determination process described above, a certain amount of liquid that allows the liquid application member 451 to execute the liquid application subsequently can be stably provided for the liquid supply member 45 and/or the liquid application member 451. As a result, the frequency of the liquid supply operation from the second liquid storage tank 91 to the first liquid storage tank 43 can be reduced, and the efficiency of the liquid application process can be enhanced.

A description is given below of the relation between the liquid supply determination process described with reference to FIG. 13 including FIGS. 13A and 13B and the change in the amount (liquid level) of the liquid stored in the first liquid storage tank 43 described with reference to FIGS. 12A, 12B, and 12C. First, when the presence or absence of the liquid in the first liquid storage tank 43 is confirmed in the stage preceding to the state illustrated in FIG. 12A, the controller 100B determines “no liquid” (NO in step S703) and drives the liquid supply pump 92 to supply the liquid from the second liquid storage tank 91 to the first liquid storage tank 43 in step S706. When the amount (liquid level) of the liquid stored in the first liquid storage tank 43 reaches the state of FIG. 12A, the output value (voltage) from the first liquid-level sensor 43a becomes equal to or greater than the liquid detection threshold value (e.g., the output voltage VTh1) (YES in step S707). Then, the controller 100B stops the liquid supply pump 92 in step S708 and turns the first liquid-level sensor 43a off in step S709.

Subsequently, when the first predetermined time TO, which is set in advance as a time for the liquid supply member 45 to suck up the liquid, elapses as illustrated in FIG. 12B, in step S711, the controller 100B turns on (energizes) the first liquid-level sensor 43a again. At this stage, a predetermined amount of liquid is sucked up by the liquid supply member 45 from the first liquid storage tank 43 to the liquid supply member 45. As a result, the amount of liquid stored in the first liquid storage tank 43 decreases, and the liquid level (amount of liquid stored) in the first liquid storage tank 43 decreases, so that the output value (voltage) from the first liquid-level sensor 43a becomes less than the liquid detection threshold value (e.g., the output voltage VTh1) (NO in step S712). Then, the controller 100B operates the liquid supply pump 92 again in step S713, and supplies the liquid from the second liquid storage tank 91 to the first liquid storage tank 43 until the output value from the first liquid-level sensor 43a becomes equal to or greater than the liquid detection threshold value (e.g., the output voltage VTh1) (YES in step S714). When the output value (voltage) from the first liquid-level sensor 43a becomes equal to or greater than the liquid detection threshold value (e.g., the output voltage VTh1), the controller 100B stops the liquid supply pump 92 in step S715, and turns the first liquid-level sensor 43a off in step S704. As a result, as illustrated in FIG. 12C, the liquid in the first liquid storage tank 43 is sufficiently stored in the entire liquid supply member 45 and/or the entire liquid application member 451. In step S705, the controller 100B displays a completion notice of the preparation for liquid application on the operation panel 110.

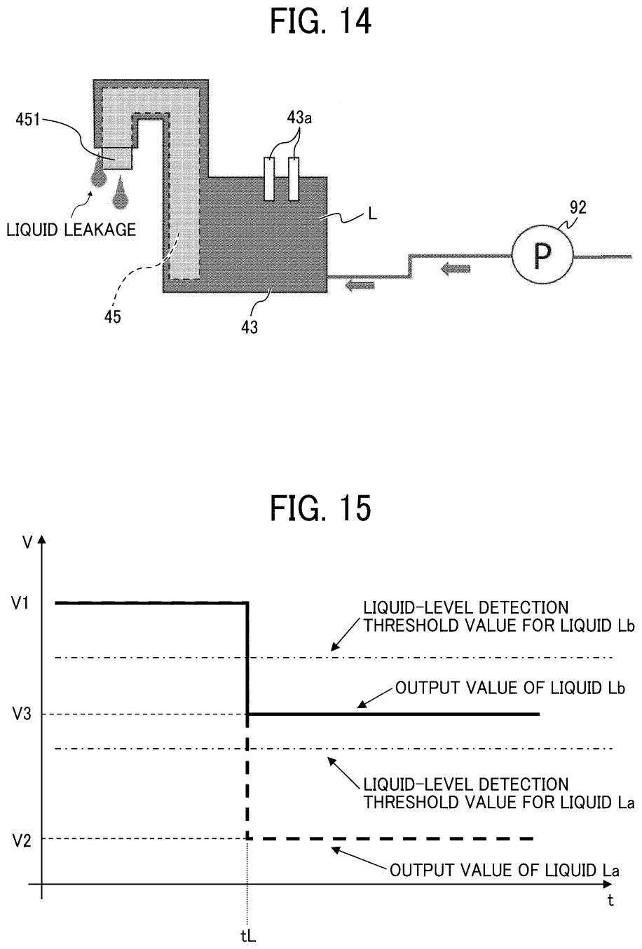

FIG. 14 is a diagram illustrating liquid leakage that might occur in the liquid applier 31 according to the present embodiment.

The liquid applier 31 according to the present embodiment supplies liquid to the second liquid storage tank 91. Accordingly, the properties (e.g., hardness, pH, chlorine content, and conductance) of the liquid vary depending on the type of the liquid supplied to the second liquid storage tank 91. In other words, when the presence or absence of liquid (the amount of liquid stored) in the first liquid storage tank 43 is determined based on the output value (voltage) of the first liquid-level sensor 43a, it is assumed that a situation may arise in which it is difficult to accurately detect the presence or absence of liquid (the amount of liquid stored) in the first liquid storage tank 43 even if the determination is made while the liquid detection threshold value is fixed at a specific value.

For example, it is assumed that the liquid supplied into the first liquid storage tank 43 is a liquid having extremely low conductance (e.g., ultrapure water used in the industrial field). It is further assumed that the liquid detection threshold value set on the premise of tap water is used. In such a case, even when the liquid in the first liquid storage tank 43 contacts the first liquid-level sensor 43a, the output value (output value of ultrapure water) at that time may not satisfy the condition for detecting the liquid (liquid level) in the first liquid storage tank 43 in comparison with the liquid detection threshold value set on the premise of tap water. As a result, the supply of the liquid to the first liquid storage tank 43 by the liquid supply pump 92 would not be stopped at an appropriate timing, and the first liquid storage tank 43 would entirely be filled with the liquid, which may cause a failure such as a gap between the liquid supply member 45 and the first liquid storage tank 43 or liquid leakage from the tip of the liquid application member 451 as illustrated in FIG. 14.

For this reason, the liquid applier 31 according to the present embodiment varies the liquid detection threshold value used for determining the presence or absence of the liquid in the first liquid-level sensor 43a depending on the type of the liquid. FIG. 15 is a graph illustrating the relation between the change in the output value from the first liquid-level sensor 43a and the liquid detection threshold value of the first liquid-level sensor 43a in time series. In FIG. 15, the horizontal axis t represents the elapsed time when the liquid supply pump 92 is operated to supply the liquid from the second liquid storage tank 91 to the first liquid storage tank 43, and the vertical axis V represents the output value (voltage) of the first liquid-level sensor 43a.

Before the pair of electrodes of the first liquid-level sensor 43a comes into contact with the liquid in the first liquid storage tank 43, the air is detected with the first liquid-level sensor 43a. The output value (voltage) of the first liquid-level sensor 43a at this time is referred to as “V1.” If the liquid type is “La” of a given conductance, the output value (voltage) is assumed to change from “V1” to “V2” when the liquid La contacts the electrodes at the elapsed time tL. Then, in order to detect the liquid La, the liquid detection threshold value of the first liquid-level sensor 43a is set between the output value V1 and the output value V2.

The liquid detection threshold value of the first liquid-level sensor 43a is preferably set to an intermediate value between the output value V1 and the output value V2 in consideration of, for example, variations and noise in the output value V1 and the output value V2.

In addition, in the case where the liquid type is not “La” but “Lb” having a lower conductance than “La”, the output value is assumed to change from “V1” to “V3” when the liquid Lb comes into contact with the electrodes. The output value V3 is assumed to be larger than the output value V2 and smaller than the output value V1. In this case, when the liquid Lb comes into contact with the electrodes at the elapsed time tL, the output value changes from “V1” to “V3” and does not reach “V2.” In other words, even if the liquid detection threshold value of the first liquid-level sensor 43a (liquid detection threshold value for the liquid La) is set to the middle of the output value V1 and the output value V2 as illustrated in FIG. 15, the liquid level (liquid storage amount) of the liquid Lb in the first liquid storage tank 43 is not detected by the first liquid-level sensor 43a.

For this reason, in the case of the liquid Lb, the liquid detection threshold value of the first liquid-level sensor 43a is set between the output value V1 and the output value V3, not between the output value V1 and the output value V2. In other words, the liquid detection threshold value of the first liquid-level sensor 43a is changed depending on the type of the liquid such that the first liquid-level sensor 43a can accurately detect the liquid (liquid level) in the first liquid storage tank 43.

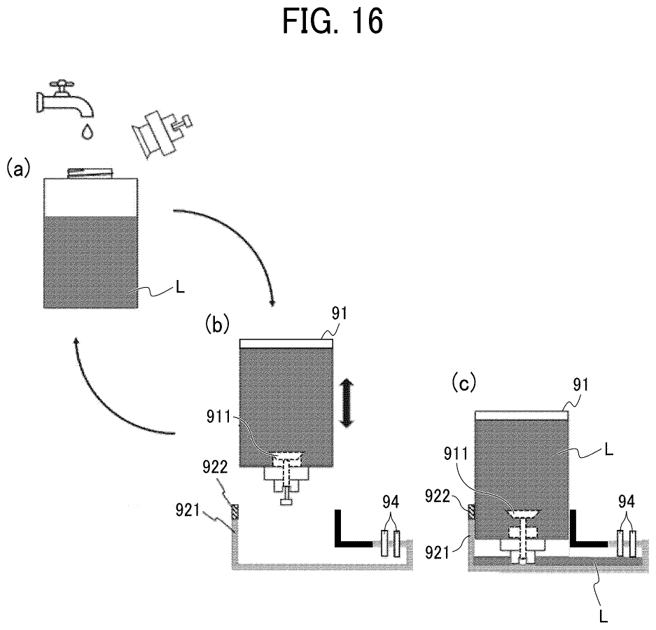

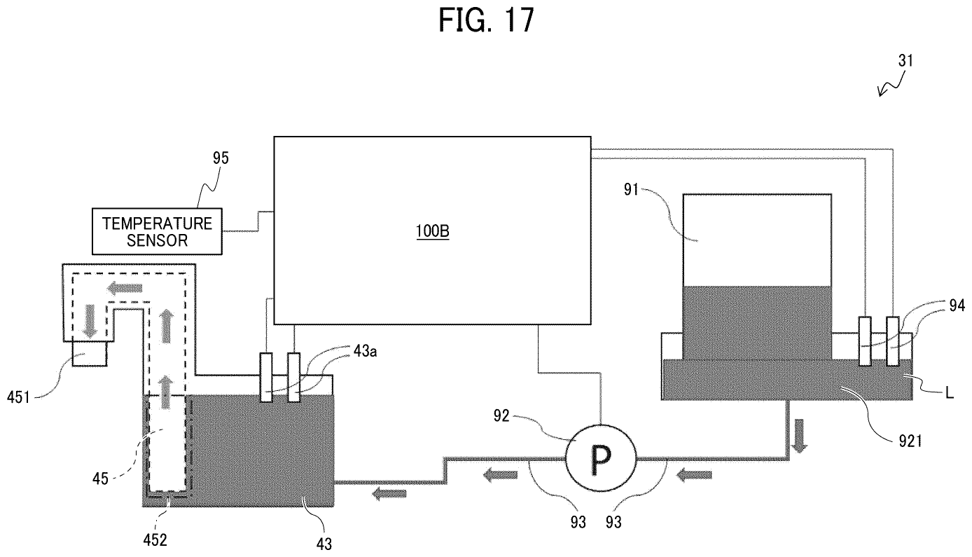

FIG. 16 is a diagram illustrating the second liquid storage tank 91 disposed in the liquid applier 31 according to the present embodiment. The second liquid storage tank 91 serving as a second liquid storage is installed at a position at which the second liquid storage tank 91 can be accessed when a cover 3a of the post-processing apparatus 3 is opened. When the second liquid storage tank 91 is replenished with liquid, the second liquid storage tank 91 is removed from the post-processing apparatus 3, and the liquid can be replenished (see part (a) of FIG. 16).

The second liquid storage tank 91 is provided with a liquid supply valve 911 inside. The liquid supply valve 911 is configured to block an outlet when the second liquid storage tank 91 is not mounted in the post-processing apparatus 3 (unmounted state), and is configured to prevent leakage of the liquid (part (b) of FIG. 16).

When the second liquid storage tank 91 is mounted to a second liquid-storage-tank fixing portion 921 (a portion of the second liquid storage) disposed in the post-processing apparatus 3, the liquid supply valve 911 is pushed up to open the outlet. As a result, the liquid held in the second liquid storage tank 91 flows out to the second liquid-storage-tank fixing portion 921 and is temporarily stored in the second liquid-storage-tank fixing portion 921. The liquid stored in the second liquid-storage-tank fixing portion 921 can be supplied to the first liquid storage tank 43 by the operation of the liquid supply pump 92.

The second liquid-storage-tank fixing portion 921 is provided with a mount detection sensor 922 (mount detector) as a sensor for determining whether the second liquid storage tank 91 is mounted. When the mount detection sensor 922 detects the mount state of the second liquid storage tank 91 to the second liquid-storage-tank fixing portion 921 (see part (c) of FIG. 16), a signal indicating the mount state is notified to the controller 100B. Thus, the controller 100B detects whether the second liquid storage tank 91 is mounted in the second liquid-storage-tank fixing portion 921.

The second liquid-level sensor 94 (serving as second liquid detector) that detects the amount of the liquid L to be stored is disposed in the second liquid-storage-tank fixing portion 921. The output value (voltage) of the second liquid-level sensor 94 is notified to the controller 100B. The controller 100B determines the output value (voltage) of the second liquid-level sensor 94 to determine whether the amount of liquid stored in the second liquid-storage-tank fixing portion 921 is a required amount of liquid. When the controller 100B determines that the second liquid storage tank 91 is in the mount state based on the output signal of the mount detection sensor 922, the controller 100B turns on the second liquid-level sensor 94 such that the presence or absence of the liquid (the amount of the liquid stored) in the second liquid-storage-tank fixing portion 921 can be detected.

A description is given below of a second embodiment of the present disclosure.

Specifically, a medium processing apparatus according to a second embodiment of the present disclosure is described below. FIG. 17 is a diagram illustrating a liquid applier 31 according to the present embodiment. A second liquid-level sensor 94 is disposed in a second liquid storage tank 91 serving as a second liquid storage. The second liquid-level sensor 94 serving as the second liquid detector is also an electrode sensor including a pair of electrodes, similarly to the first liquid-level sensor 43a. When liquid contacts the electrodes, the controller 100B determines the variation of the output value (voltage) caused by the voltage applied between the electrodes, thus allowing detection of the presence or absence of the liquid (the amount of the liquid stored) in the second liquid-storage-tank fixing portion 921. The second liquid-level sensor 94 is not limited to the electrode sensor as in the case of the first liquid-level sensor 43a, and may be of another type. For example, a float sensor or a capacitance sensor may be used to detect the presence or absence of the liquid. The second liquid-level sensor 94 is not limited to a sensor for detecting the liquid level (liquid surface) of the liquid in the second liquid-storage-tank fixing portion 921, and may be any sensor that can detect the presence or absence of the liquid (the amount of the liquid stored) in the second liquid-storage-tank fixing portion 921.

The liquid applier 31 according to the present embodiment is more effective, for example, when the first liquid-level sensor 43a disposed in the first liquid storage tank 43 cannot detect the presence or absence of liquid (the amount of liquid stored) in the first liquid storage tank 43 because the type of liquid in the second liquid storage tank 91 is different from the type of liquid in the first liquid storage tank 43.

As illustrated in FIG. 16, when the second liquid storage tank 91 is removed from the post-processing apparatus 3 and the second liquid storage tank 91 is replenished with liquid, the type (property) of the replenished liquid may be changed. For example, the liquid in the second liquid storage tank 91 and the second liquid-storage-tank fixing portion 921 may be changed from the liquid La illustrated in FIG. 15 to the liquid Lb. In this case, the liquid detection threshold value of the first liquid-level sensor 43a is set to the “liquid detection threshold value for the liquid La” illustrated in FIG. 15. For this reason, first, the controller 100B turns the second liquid-level sensor 94 on when the second liquid storage tank 91 is mounted. At this time, the output value (voltage) of the second liquid-level sensor 94 is a value (e.g., output voltage V3) indicating a state in which the liquid Lb in the second liquid storage tank 91 is detected. Then, the liquid detection threshold value of the first liquid-level sensor 43a is changed from the “liquid detection threshold value for the liquid La” illustrated in FIG. 15 to the “liquid detection threshold value for the liquid Lb” based on the output value (e.g., the output voltage V3) of the second liquid-level sensor 94. In this case, the controller 100B determines the output value (voltage) of the first liquid-level sensor 43a using the newly set liquid detection threshold value (“liquid detection threshold value for the liquid Lb”) to determine the presence or absence of the liquid (the amount of liquid stored) in the first liquid storage tank 43.

When there is another possibility that the type (property) of the liquid used for liquid application has changed, the liquid detection threshold value may be positively reviewed. For example, a case is assumed in which the property of the liquid is changed due to a change in the ambient temperature of the first liquid storage tank 43 and/or the second liquid storage tank 91. In this case, the liquid detection threshold value may be reviewed when the ambient temperature detected by the temperature sensor 95 (serving as a temperature detector) provided for detecting the ambient temperature of the first liquid storage tank 43 and/or the second liquid storage tank 91 exceeds a predetermined fluctuation range compared with when the liquid supply determination process was previously executed. The predetermined fluctuation range is, for example, ±10° C.

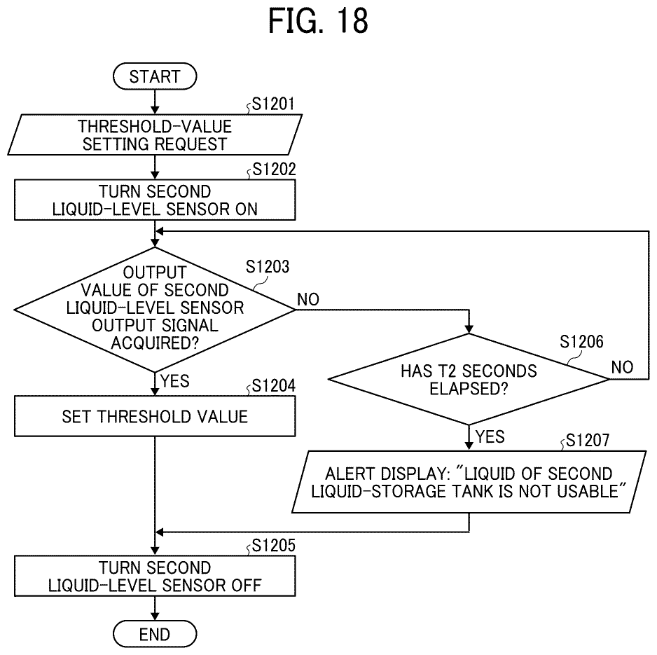

A description is given below of a process of setting the liquid detection threshold value. FIG. 18 is a flowchart of a liquid-detection threshold-value setting process executed by the controller 100B. The liquid-detection threshold-value setting process according to the present embodiment is executed when there is a possibility that the type of liquid supplied to the second liquid storage tank 91 has been changed or when the ambient temperature exceeds a predetermined fluctuation range.

For example, when the liquid-detection threshold-value setting process is started, a threshold-value setting request is instructed to the controller 100B in step S1201. The instruction of the threshold-value setting request may be based on information input by the user from the operation panel 110. Following the threshold-value setting request, in step S1202, the controller 100B applies a voltage to the second liquid-level sensor 94 (i.e., turns the second liquid-level sensor 94 on).

A predetermined time is required from the time when the second liquid storage tank 91 is mounted in the second liquid-storage-tank fixing portion 921 to the time when the second liquid-storage-tank fixing portion 921 is filled with the liquid. For this reason, when the output value of the second liquid-level sensor 94 is not acquired (NO in step S1203) and the liquid supply time T2 as the second predetermined time has not elapsed (NO in step S1206), the controller 100B loops the process.

When the controller 100B acquires the output value of the second liquid-level sensor 94 (YES in step S1203), in step S1204, the controller 100B sets the liquid detection threshold value of the first liquid-level sensor 43a based on the acquired output value (voltage). In step S1205, the controller 100B stops the application of the voltage to the second liquid-level sensor 94 (turns the second liquid-level sensor 94 off), and ends the process of setting the liquid detection threshold value.

Alternatively, if the controller 100B cannot acquire the output value of the second liquid-level sensor 94 before the liquid supply time T2 elapses (NO in step S1203 and YES in S1206), for example, a situation in which the conductance of the liquid to be used is extremely low is assumed. In this case, since the liquid supplied to the second liquid storage tank 91 is not suitable for the liquid application by the liquid applier 31, in step S1207, the controller 100B executes the process of notifying, for example, the operation panel 110 that the liquid supplied to the second liquid storage tank 91 is not usable for the liquid application. In step S1205, the controller 100B stops the application of the voltage to the second liquid-level sensor 94 (i.e., turns the second liquid-level sensor 94 off), and ends the liquid-detection threshold-value setting process.

A description is given of a third embodiment of the present disclosure.

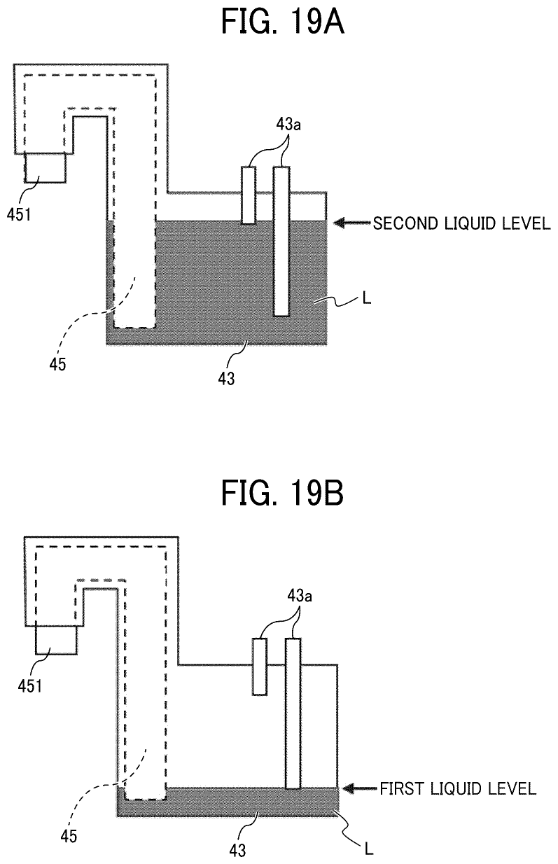

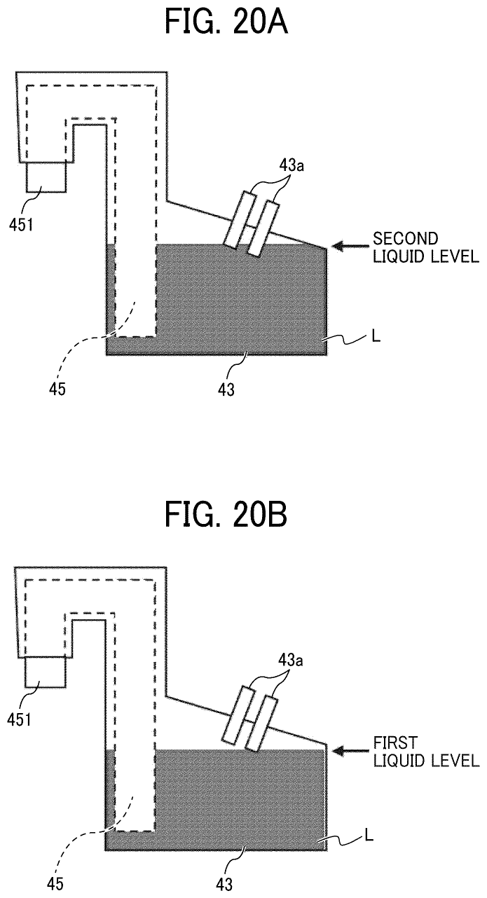

Specifically, a medium processing apparatus according to a third embodiment of the present disclosure is described below. FIGS. 19A and 19B and FIGS. 20A and 20B are diagrams illustrating a part of the liquid applier 31 according to the present embodiment. As illustrated in FIGS. 19A and 19B, the first liquid-level sensor 43a of the liquid applier 31 according to the present embodiment employs electrodes of different lengths, one of which is longer than the other (or one of which is shorter than the other). The larger the area of the electrodes in contact with the liquid, the larger the conductance, and therefore the liquid level (liquid surface) of the liquid in the first liquid storage tank 43 can be easily detected. For this reason, as illustrated in FIG. 19, when the length of one electrode is increased, the liquid level at which the liquid contacts the longer electrode is set as the first liquid level, and the liquid level at which the liquid contacts the shorter electrode is set as the second liquid level. The controller 100B determines whether the liquid level (liquid surface) of the liquid in the first liquid storage tank 43 reaches the reference liquid level, based on whether the second liquid level is exceeded.

The above-described configuration of the first liquid-level sensor 43a allows the first liquid-level sensor 43a to accurately detect the change in the amount of liquid stored until the amount of liquid stored (liquid level) in the first liquid storage tank 43 reaches the reference liquid level. This makes it possible to accurately control the supply of the liquid from the second liquid storage tank 91 to the first liquid storage tank 43 by the liquid supply pump 92.

As illustrated in FIG. 20, a pair of electrodes of the first liquid-level sensor 43a is disposed in a state of being inclined with respect to the liquid (liquid level) in the first liquid storage tank 43. In the example of the arrangement of FIGS. 20A and 20B, the liquid level at which the liquid contacts the electrode disposed at a lower position (a position closer to the liquid) is set as a first liquid level, and the liquid level at which the liquid contacts the electrode disposed at a higher position (a position farther from the liquid) is set as a second liquid level. The controller 100B determines whether the liquid level (liquid surface) of the liquid in the first liquid storage tank 43 reaches the reference liquid level, based on whether the second liquid level is exceeded.

When the pair of electrodes is disposed obliquely with respect to the liquid (liquid surface) in the first liquid storage tank 43, the detection accuracy of the liquid level (liquid surface) of the liquid in the first liquid storage tank 43 can be enhanced even if the electrodes have the same length. In this case, since the pair of electrodes can be commonized (since both the pair of electrodes can be short electrodes), the cost of components can be reduced as compared with the first liquid-level sensor 43a illustrated in FIG. 19 in which the lengths of the electrodes are different.

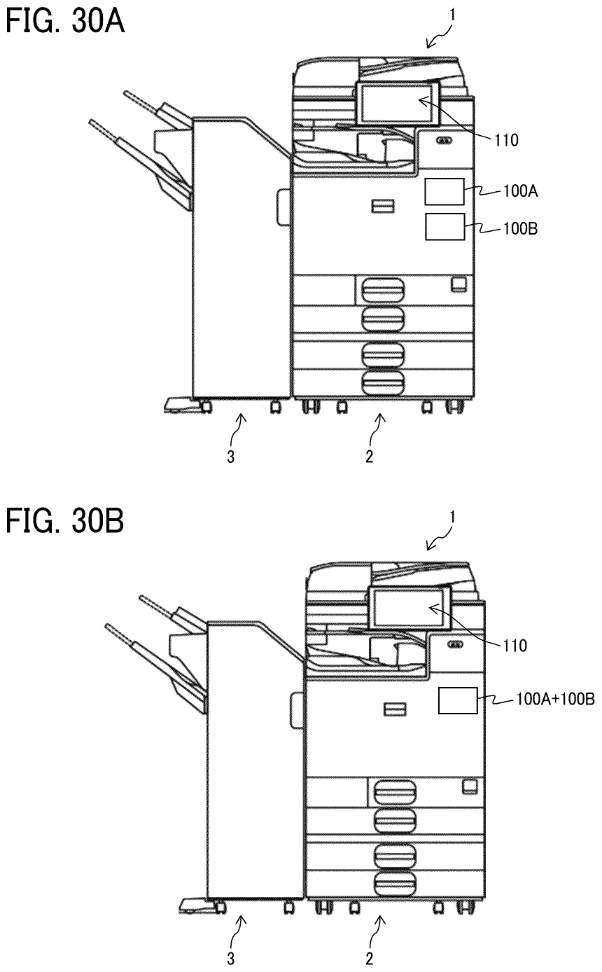

In the above description, the controller 100B of the post-processing apparatus 3 is provided separately from the controller 100A of the image forming apparatus 2 as illustrated in FIG. 1. However, embodiments of the present disclosure are not limited to the above-described configuration. For example, as illustrated in FIG. 30A, the controller 100B of the post-processing apparatus 3 may be disposed in the image forming apparatus 2. Further, as illustrated in FIG. 30B, the controller 100B of the post-processing apparatus 3 may be integrated with the controller 100A of the image forming apparatus 2.

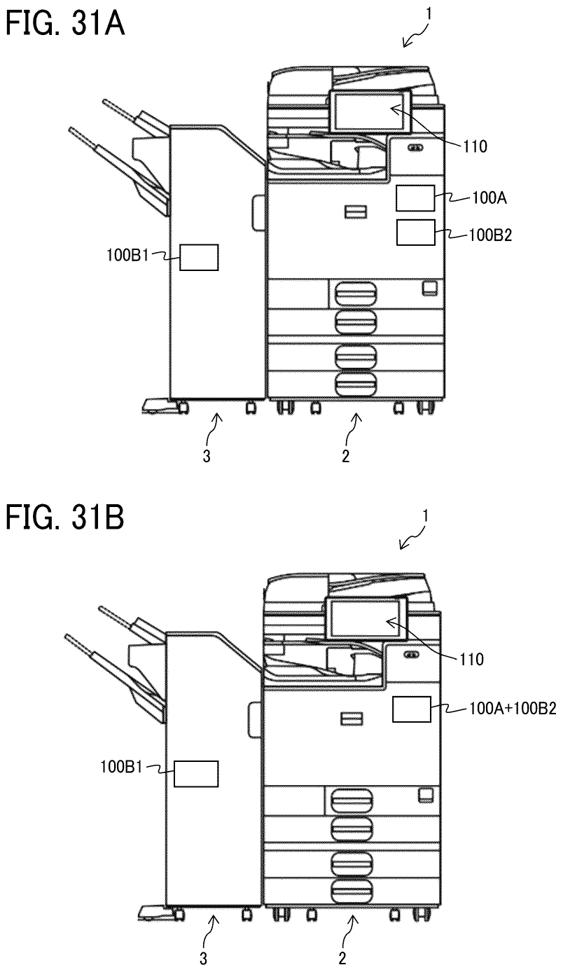

As illustrated in FIG. 31A, the controller 100B of the post-processing apparatus 3 may be divided into a controller 100B1 (e.g., a driver system such as a motor) and a controller 100B2 (a detector such as a sensor) according to the function, and the controller 100B2 of the post-processing apparatus 3 may be disposed in the image forming apparatus 2. Further, as illustrated in FIG. 31B, the controller 100B2 of the post-processing apparatus 3 disposed in the image forming apparatus 2 may be integrated with the controller 100A of the image forming apparatus 2.

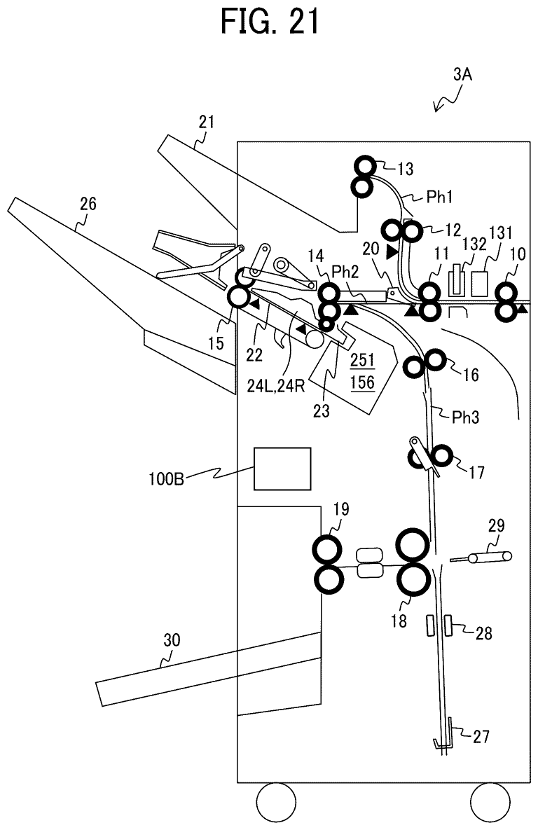

A description is given of the post-processing apparatus 3 according to another embodiment of the present disclosure. A post-processing apparatus 3A according to another embodiment is described below with reference to FIGS. 21 to 29. In the following description, components like those of the above-described embodiment are denoted by like reference numerals, and detailed descriptions thereof may be omitted.

The post-processing apparatus 3A according to another embodiment includes an edge binder 251. The edge binder 251 is different from the edge binder 25 of the post-processing apparatus 3 according to the first embodiment, in which the liquid applier 131 and the crimper 32 are arranged side by side, in that the edge binder 251 includes a crimper 32′and a liquid applier 131 is disposed at an upstream position in a direction in which a sheet P is conveyed. Such a configuration allows a given number of sheets P to be stacked after the liquid application process and conveyed to the crimper 32′ of the edge binder 251 disposed at a downstream position in the direction in which the sheet P is conveyed. Accordingly, the productivity of the binding process performed by the crimper 32′ is enhanced.

Since the direction in which the conveyance roller pairs 10, 11, and 14 convey the sheet P is opposite to the “conveyance direction” defined above, the direction in which the conveyance roller pairs 10, 11, and 14 convey the sheet P is defined as an “opposite conveyance direction” in the following description. A direction that is orthogonal to both the opposite conveyance direction and the thickness direction of the sheet P is defined as the “main scanning direction” or the “width direction of the sheet P.” The liquid application position to which the liquid is applied on the sheet P or the sheet bundle Pb by the liquid applier 131 corresponds to the binding position on the sheet bundle Pb to be crimped by the crimper 32′. For this reason, in the following description, the liquid application position and the binding position are denoted by the same reference sign.

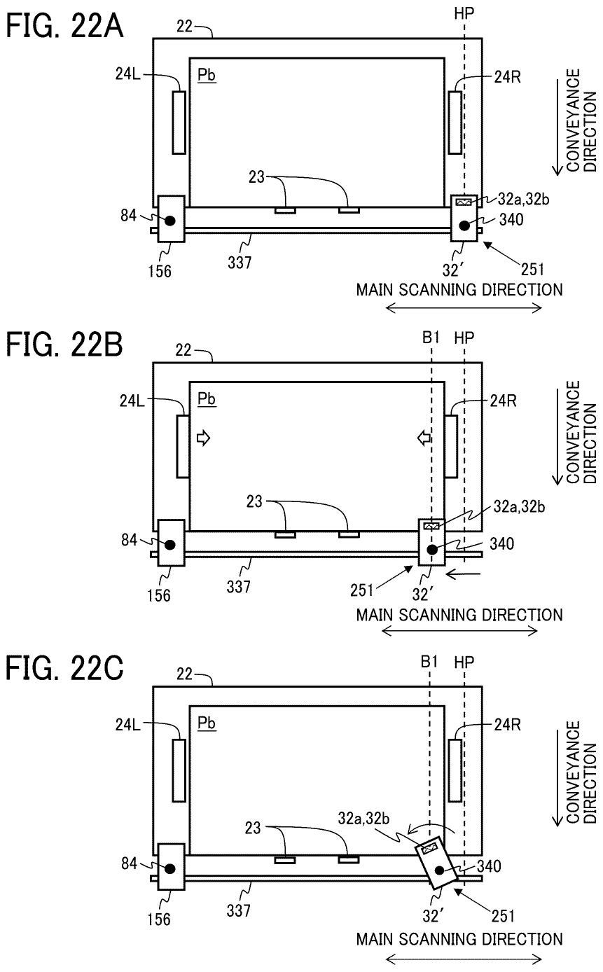

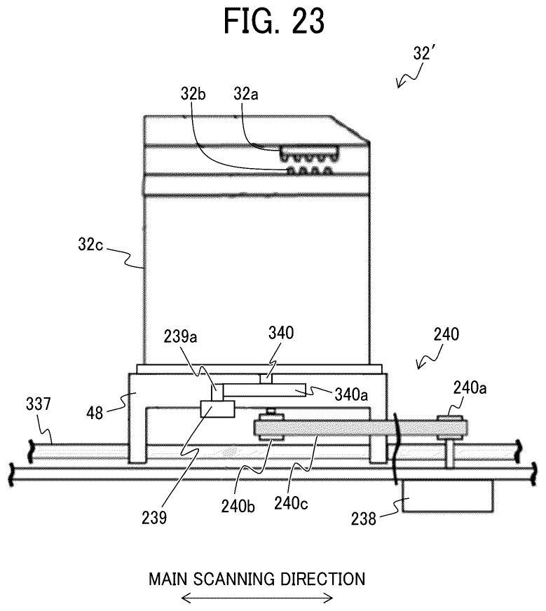

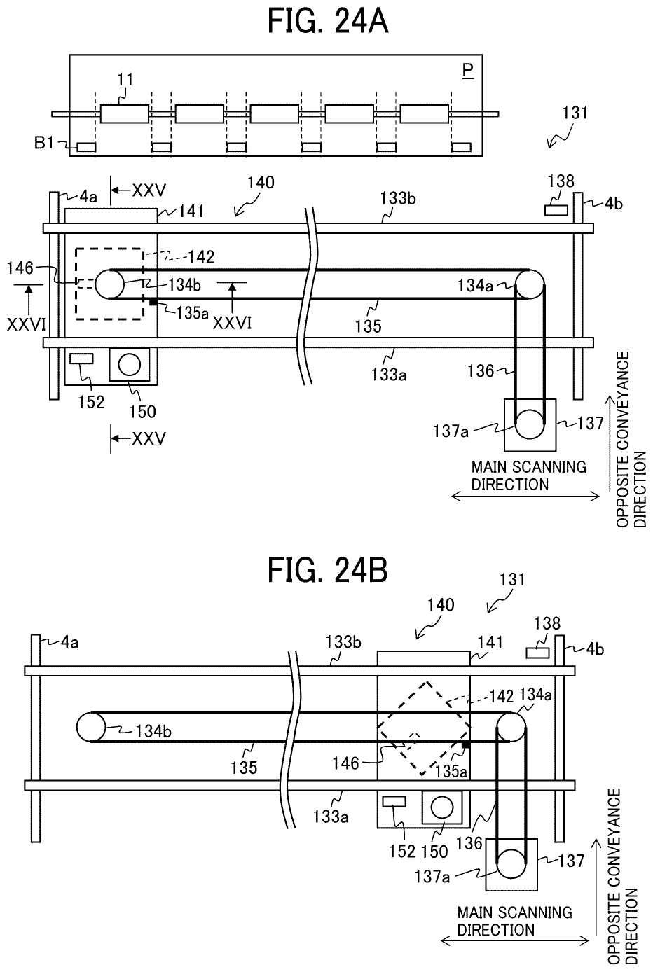

FIG. 21 is a diagram illustrating an internal configuration of the post-processing apparatus 3A according to another embodiment of the present disclosure. As illustrated in FIGS. 22A, 22B, and 22C, the edge binder 251 includes only the crimper 32′. As illustrated in FIGS. 24A to 24C, the crimper 32′ and the stapler 156 are disposed downstream from the internal tray 22 in the conveyance direction. In addition, the crimper 32′ and the stapler 156 are located to face a downstream end, in the conveyance direction, of a sheet bundle Pb placed on the internal tray 22 and move in the main scanning direction. Further, the crimper 32′ and the stapler 156 are respectively rotatable in the forward and reverse directions about a crimper shaft 340 and a stapler shaft 84 both extending in the thickness direction of the sheet bundle Pb placed on the internal tray 22. In other words, the crimper 32′ and the stapler 156 bind, at a desired angle, a desired position in the main scanning direction on the sheet bundle Pb placed on the internal tray 22 in, for example, corner oblique binding, parallel one-point binding, or parallel two-point binding.

The crimper 32′ presses and deforms the sheet bundle Pb with the serrate upper crimping teeth 32a and the serrate lower crimping teeth 32b to bind the sheet bundle Pb. In the following description, such a binding way may be referred to as “crimping.” In other words, the crimper 32′crimps and binds the sheet bundle Pb or performs the crimping on the sheet bundle Pb. On the other hand, the stapler 156 penetrates a staple through a binding position on a sheet bundle Pb placed on the internal tray 22 to staple the sheet bundle Pb.

FIGS. 22A, 22B, and 22C are schematic views of the internal tray 22 as viewed from the thickness direction of the sheet bundle Pb. FIG. 23 is a schematic view of the crimper 32′ as viewed from the conveyance direction. As illustrated in FIGS. 22A, 22B, and 22C, the crimper 32′ and the stapler 156 are disposed downstream from the internal tray 22 in the conveyance direction. The crimper 32′ is movable in the main scanning direction along the surface of the sheet bundle Pb placed on the internal tray 22. The crimper 32′ is also rotatable in the forward and reverse directions about the crimper shaft 340 extending in the thickness direction of the sheet bundle Pb placed on the internal tray 22. Similarly, the stapler 156 is movable in the main scanning direction of the sheet bundle Pb and is rotatable in the forward and reverse directions about the stapler shaft 84 extending in the thickness direction of the sheet bundle Pb. The other components of the stapler 156 are similar to, even if not the same as, those of the second staple binder 55 (see FIG. 6) of the post-processing apparatus 3 according to the first embodiment. Therefore, a detailed description thereof is omitted.

More specifically, as illustrated in FIG. 23, the crimper 32′ includes a guide rail 337 extending in the main scanning direction at a position downstream from the internal tray 22 in the conveyance direction. The crimper 32′ is moved in the main scanning direction along the surface of the sheet bundle Pb placed on the internal tray 22, in other words, along the guide rail 337, by the driving force that is transmitted from a crimper movement motor 238 by a drive transmission assembly 240 including a pulley 240a, a pulley 240b, and a timing belt 240c. The crimping frame 32c holds the components of the crimper 32′. The crimper shaft 340 serving as a rotation shaft having a drive transmission gear 340a is fixed to a bottom surface of the crimping frame 32c. The crimper shaft 340 and the drive transmission gear 340a are held by the base 48 on which the crimping frame 32c is disposed, so as to be rotatable in the forward and reverse directions. The drive transmission gear 340a meshes with an output gear 239a of a crimper pivot motor 239. When the driving force of the crimper pivot motor 239 is transmitted to the crimper shaft 340 via the output gear 239a and the drive transmission gear 340a, the crimper 32′ rotates in the forward and reverse directions on the base 48 about the crimper shaft 340 extending in the thickness direction of the sheet P placed on the internal tray 22. The guide rail 337, the crimper movement motor 238, the crimper pivot motor 239, the crimper shaft 340, and the drive transmission assembly 240 constitute at least part of a driving assembly of the crimper 32′ according to the present embodiment.

The crimper 32′ is movable between a standby position HP illustrated in FIG. 22A and a position where the crimper 32′faces the binding position B1 illustrated in FIGS. 22B and 22C. The standby position HP is away in the main scanning direction from the sheet bundle Pb placed on the internal tray 22. For example, in FIGS. 22A, 22B, and 22C, the standby position HP is away from the right side of the sheet bundle Pb in the main scanning direction. The binding position B1 is a position on the sheet bundle Pb placed on the internal tray 22. However, the specific position of the binding position B1 is not limited to the position illustrated in FIGS. 22B and 22C. The binding position B1 may be one or more positions along the main scanning direction at the downstream end, in the conveyance direction, of the sheet P.

The posture of the crimper 32′changes or is pivoted between a parallel binding posture illustrated in FIG. 22B and an oblique binding posture illustrated in FIG. 22C. In other words, the crimper 32′is rotatable in the forward and reverse directions about the crimper shaft 340. The parallel binding posture is a posture of the crimper 32′in which the longitudinal direction of the upper crimping teeth 32a and the lower crimping teeth 32b (in other words, a rectangular crimp binding trace) is along the main scanning direction. The oblique binding posture is a posture of the crimper 32′in which the longitudinal direction of the upper crimping teeth 32a and the lower crimping teeth 32b (i.e., the rectangular crimp binding trace) is inclined with respect to the main scanning direction.

The pivot angle, which is an angle of the upper crimping teeth 32a and the lower crimping teeth 32b with respect to the main scanning direction, in the oblique binding posture is not limited to the angle illustrated in FIG. 22C. The pivot angle in the oblique binding posture may be any angle provided that the upper crimping teeth 32a and the lower crimping teeth 32b face the sheet bundle Pb placed on the internal tray 22.

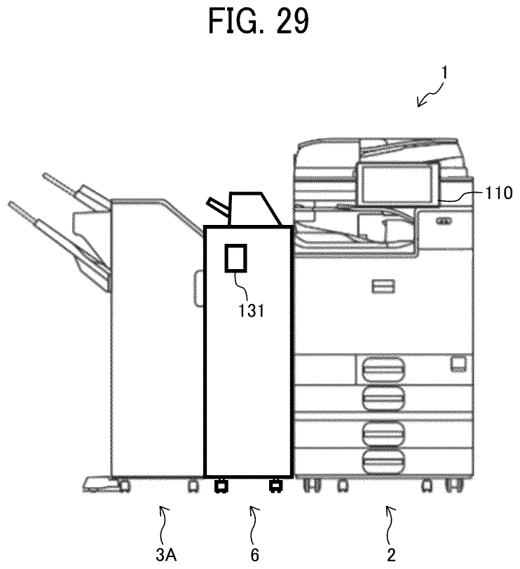

The post-processing apparatus 3A includes the liquid applier 131 and a hole punch 132 serving as a processor. The liquid applier 131 and the hole punch 132 are disposed upstream from the internal tray 22 in the opposite conveyance direction. In addition, the liquid applier 131 and the hole punch 132 are disposed at different positions in the opposite conveyance direction to simultaneously face one sheet P that is conveyed by the conveyance roller pairs 10 to 19. The liquid applier 131 and the hole punch 132 according to the present embodiment are disposed between the conveyance roller pairs 10 and 11. However, the arrangement of the liquid applier 131 is not limited to the example of FIG. 21. For example, in a case where an inserter 6 is disposed between the image forming apparatus 2 and the post-processing apparatus 3A as illustrated in FIG. 29, the liquid applier 131 may be disposed inside the inserter 6 located upstream from the post-processing apparatus 3A in a direction in which the sheet P is conveyed from the image forming apparatus 2 to the post-processing apparatus 3A. Examples of the inserter 6 include, but are not limited to, an apparatus that allows a pre-printed medium, which is to be conveyed to the post-processing apparatus 3A together with the sheet P conveyed from the image forming apparatus 2, to be fed as a cover sheet, an insertion sheet, or a partition sheet without passing through the image forming apparatus 2.

As illustrated in FIG. 24A, the conveyance roller pair 11 is located so as not to overlap, in the main scanning direction, the liquid application position B1 on the sheet P to which the liquid has been applied by a liquid application head 146 of the liquid applier 131. This arrangement is to prevent the amount of liquid at the liquid application position B1 from decreasing due to the multiple roller pairs pressing the liquid application position B1 when the conveyance roller pair 11 conveys the sheet P. As a result, when the sheet P reaches the crimper 32′ disposed downstream from the liquid applier 131 in the opposite conveyance direction, the amount of liquid at the liquid application position B1 is sufficient to maintain the binding strength. Accordingly, the binding strength of the sheet bundle Pb is prevented from decreasing due to a decrease in the amount of liquid at the liquid application position B1 (corresponding to the binding position B1) while the sheet P is conveyed.

In addition, the multiple roller pairs of the conveyance roller pair 11 that is located so as not to overlap the liquid application position B1 on the sheet P in the main scanning direction prevents the conveying performance of the sheet P from being worse due to the adhesion of liquid to the multiple roller pairs and further prevents a conveyance jam caused by the worsened conveying performance of the sheet P.

Although only the conveyance roller pair 11 has been described above, the multiple roller pairs of the conveyance roller pairs 14 and 15 are preferably located so as not to overlap the liquid application position B1 on the sheet P in the main scanning direction, like the multiple roller pairs of the conveyance roller pair 11.

The liquid applier 131 applies liquid to the sheet P that is conveyed by the conveyance roller pairs 10 and 11. In the following description, the application of liquid may be referred to as “liquid application.” The hole punch 132 punches a hole in the sheet P that is conveyed by the conveyance roller pairs 10 and 11 such that the hole penetrates the sheet P in the thickness direction of the sheet P. The processor disposed near the liquid applier 131 is not limited to the hole punch 132. Alternatively, the processor may be an inclination corrector that corrects an inclination or skew of the sheet P that is conveyed by the conveyance roller pairs 10 and 11.

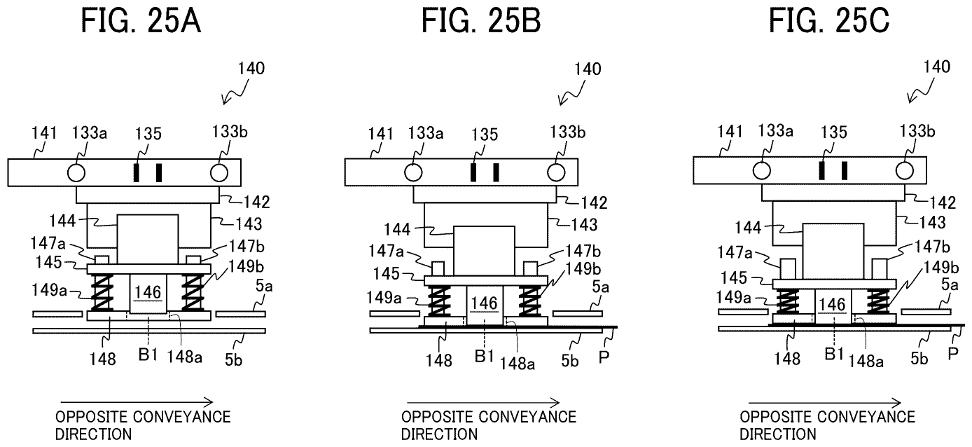

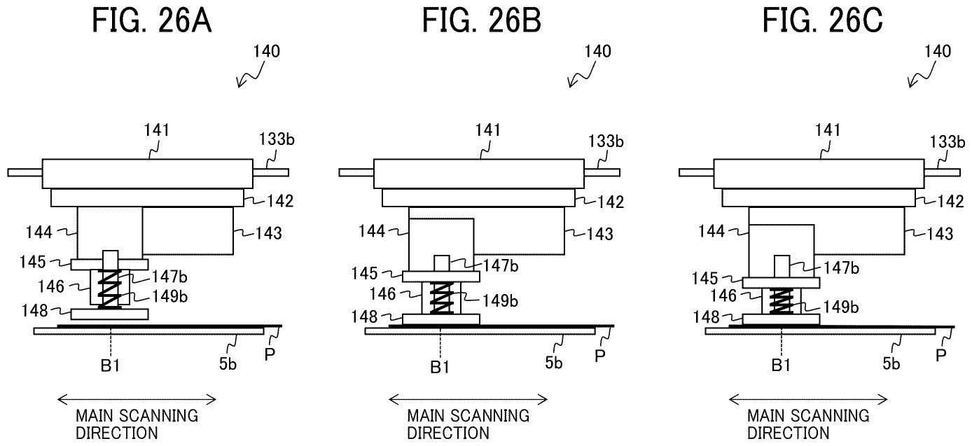

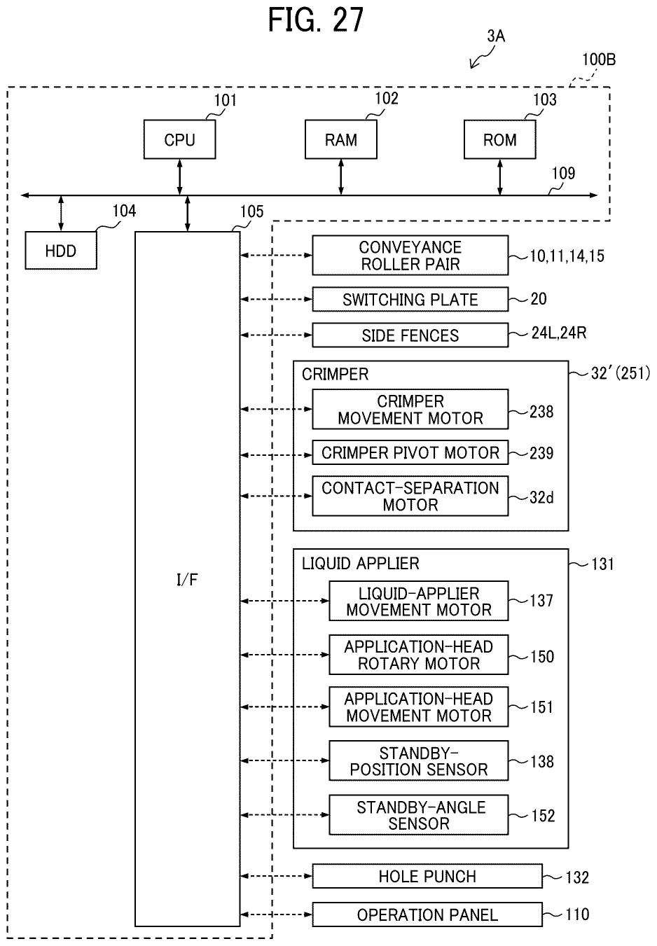

FIGS. 24A and 24B are schematic views of the liquid applier 131 in the thickness direction of the sheet P, according to another embodiment of the present disclosure. FIGS. 25A, 25B, and 25C are cross-sectional views of the liquid applier 131 taken along line XXV-XXV of FIG. 24A. FIGS. 26A, 26B, and 26C are cross-sectional views of the liquid applier 131 taken along line XXVI-XXVI of FIG. 24A. As illustrated in FIGS. 24A to 26C, the liquid applier 131 includes a pair of guide shafts 133a and 133b, a pair of pulleys 134a and 134b, endless annular belts 135 and 136, a liquid-applier movement motor 137, a standby-position sensor 138 (see FIG. 27), and a liquid application unit 140.

The guide shafts 133a and 133b, each extending in the main scanning direction, are spaced apart from each other in the opposite conveyance direction. The pair of guide shafts 133a and 133b are supported by a pair of side plates 4a and 4b of the post-processing apparatus 3A.

The pair of guide shafts 133a and 133b support the liquid application unit 140 such that the liquid application unit 140 can move in the main scanning direction.

The pair of pulleys 134a and 134b is disposed between the guide shafts 133a and 133b in the opposite conveyance direction. The pulleys 134a and 134b are spaced apart from each other in the main scanning direction. The pair of pulleys 134a and 134b are supported by a frame of the post-processing apparatus 3A so as to be rotatable about an axis extending in the thickness direction of the sheet P.

The endless annular belt 135 is looped around the pair of pulleys 134a and 134b. The endless annular belt 135 is coupled to the liquid application unit 140 by a connection 135a. The endless annular belt 136 is looped around the pulley 134a and a driving pulley 137a that is fixed to an output shaft of the liquid-applier movement motor 137. The liquid-applier movement motor 137 generates a driving force to move the liquid application unit 140 in the main scanning direction.

As the liquid-applier movement motor 137 rotates, the endless annular belt 136 circulates around the pulley 134a and the driving pulley 137a to rotate the pulley 134a. As the pulley 134a rotates, the endless annular belt 135 circulates around the pair of pulleys 134a and 134b. As a result, the liquid application unit 140 moves in the main scanning direction along the pair of guide shafts 133a and 133b. The liquid application unit 140 reciprocates in the main scanning direction in response to switching of the rotation direction of the liquid-applier movement motor 137.

The standby-position sensor 138 detects that the liquid application unit 140 has reached a standby position in the main scanning direction. The standby-position sensor 138 then outputs a standby position signal indicating the detection result to the controller 100B, which will be described below with reference to FIG. 27. The standby-position sensor 138 is, for example, an optical sensor including a light emitter and a light receiver. The liquid application unit 140 at the standby position blocks an optical path between the light emitter and the light receiver. The standby-position sensor 138 outputs the standby position signal in response to the light output from the light emitter not being received by the light receiver. The specific configuration of the standby-position sensor 138 is not limited to the configuration described above.

As illustrated in FIGS. 25A, 25B, and 25C, the conveyance passage inside the post-processing apparatus 3A is defined by an upper guide plate 5a and a lower guide plate 5b, which are spaced apart from each other in the thickness direction of the sheet P. The liquid application unit 140 is located at a position to face an opening of the upper guide plate 5a. In other words, the liquid application unit 140 is disposed to face the conveyance passage (a position (at which the liquid application unit 140 is to face the sheet P conveyed along the conveyance passage) through the opening of the upper guide plate 5a.

As illustrated in FIGS. 24A to 26C, the liquid application unit 140 includes a base 141, a rotary bracket 142, a liquid storage tank 143, a mover 144, a holder 145, the liquid application head 146, columns 147a and 147b, a pressure plate 148, coil springs 149a and 149b, an application-head pivot motor 150, an application-head movement motor 151 illustrated in FIG. 27, and a standby-angle sensor 152, which is also illustrated in FIG. 27.

The base 141 is supported by the pair of guide shafts 133a and 133b so as to be slidable in the main scanning direction. The base 141 is coupled to the endless annular belt 135 by the connection 135a. The base 141 supports the components of the liquid application unit 140 such as the rotary bracket 142, the liquid storage tank 143, the mover 144, the holder 145, the liquid application head 146, the columns 147a and 147b, the pressure plate 148, the coil springs 149a and 149b, the application-head pivot motor 150, the application-head movement motor 151, and the standby-angle sensor 152.

The rotary bracket 142 is supported by a lower face of the base 141 so as to be rotatable in the forward and reverse directions about an axis extending in the thickness direction of the sheet P. The rotary bracket 142 is rotated with respect to the base 141 by a driving force transmitted from the application-head pivot motor 150. The rotary bracket 142 supports the liquid storage tank 143, the mover 144, the holder 145, the liquid application head 146, the columns 147a and 147b, the pressure plate 148, and the coil springs 149a and 149b.

The standby-angle sensor 152, which is also illustrated in FIG. 27, detects that the rotary bracket 142 has reached a standby angle. The standby-angle sensor 152 then outputs a standby angle signal indicating the detection result to the controller 100B. The standby angle is, for example, an angle for the parallel binding. The standby-angle sensor 152 is, for example, an optical sensor including a light emitter and a light receiver. The rotary bracket 142 at the standby angle blocks an optical path between the light emitter and the light receiver. The standby-angle sensor 152 outputs the standby angle signal in response to the light output from the light emitter not being received by the light receiver. The specific configuration of the standby-angle sensor 152 is not limited to the configuration described above.

FIG. 24A illustrates the rotary bracket 142 in a position for the parallel binding that is performed by the crimper 32′disposed downstream from the liquid applier 131 in a direction in which the sheet P is conveyed. FIG. 24B illustrates the rotary bracket 142 in a position for the oblique binding (i.e., corner binding) that is performed by the crimper 32′disposed downstream from the liquid applier 131 in the direction in which the sheet P is conveyed.

The liquid storage tank 143 stores liquid to be applied to the sheet P. The mover 144 is supported by the liquid storage tank 143 so as to be movable (e.g., up and down) in the thickness direction of the sheet P. The mover 144 is moved with respect to the liquid storage tank 143 by a driving force transmitted from the application-head movement motor 151. The holder 145 is attached to a lower end of the mover 144. The liquid application head 146 projects from the holder 145 toward the conveyance passage (downward in the present embodiment). The liquid that is stored in the liquid storage tank 143 is supplied to the liquid application head 146. The liquid application head 146 is made of a material having a relatively high liquid absorption (e.g., sponge or fiber).

The columns 147a and 147b project downward from the holder 145 around the liquid application head 146. The columns 147a and 147b can move relative to the holder 145 in the thickness direction. The columns 147a and 147b have respective lower ends holding the pressure plate 148. The pressure plate 148 has a through hole 148a at a position where the through hole 148a faces the liquid application head 146. The coil springs 149a and 149b are fitted around the columns 147a and 147b, respectively, between the holder 145 and the pressure plate 148. The coil springs 149a and 149b bias the columns 147a and 147b and the pressure plate 148 downward with respect to the holder 145.

As illustrated in FIGS. 25A and 26A, before the sheet P is conveyed to the position where the sheet P faces the opening of the upper guide plate 5a, the pressure plate 148 is positioned at or above the opening. Subsequently, when the sheet P that is conveyed by the conveyance roller pairs 10 and 11 stops at a position where the liquid application position B1 on the sheet P faces the opening, the application-head movement motor 151 is rotated in a first direction. As a result, the mover 144, the holder 145, the liquid application head 146, the columns 147a and 147b, the pressure plate 148, and the coil springs 149a and 149b are moved down together to allow the pressure plate 148 to contact the sheet P. The liquid application position B1 corresponds to the binding position B1 to be crimped and bound by the edge binder 251, specifically, the crimper 32′.

As the application-head movement motor 151 keeps rotating in the first direction after the pressure plate 148 contacts the sheet P, the coil springs 149a and 149b are compressed to further move down the mover 144, the holder 145, the liquid application head 146, and the columns 147a and 147b. As a result, as illustrated in FIGS. 25B and 26B, a lower face of the liquid application head 146 contacts the sheet P through the through hole 148a. Then, the liquid contained in the liquid application head 146 is applied to the sheet P.

Further rotation of the application-head movement motor 151 in the first direction further strongly presses the liquid application head 146 against the sheet P as illustrated in FIG. 25C. and 26C. Accordingly, the amount of liquid that is applied to the sheet P increases. In short, the liquid applier 131 changes the pressing force of the liquid application head 146 against the sheet P to adjust the amount of liquid that is applied to the sheet P.

Alternatively, the rotation of the application-head movement motor 151 in a second direction opposite to the first direction moves up the mover 144, the holder 145, the liquid application head 146, the columns 147a and 147b, the pressure plate 148, and the coil springs 149a and 149b together. As a result, as illustrated in FIGS. 25A and 26A, the liquid application head 146 and the pressure plate 148 are separated from the sheet P. In other words, the liquid applier 131 includes the liquid application head 146 that can be separated from the sheet P.

FIG. 27 is a block diagram illustrating a hardware configuration of the post-processing apparatus 3A to control the operation of the post-processing apparatus 3A according to another embodiment of the present disclosure. As illustrated in FIG. 27, the post-processing apparatus 3A includes a CPU 101, a RAM 102, a ROM 103, an HDD 104, and an I/F 105. The CPU 101, the RAM 102, the ROM 103, the HDD 104, and the I/F 105 are connected to each other via a common bus 109.

The CPU 101 is an arithmetic unit and controls the overall operation of the post-processing apparatus 3A. The RAM 102 is a volatile storage medium that allows data to be read and written at high speed. The CPU 101 uses the RAM 102 as a working area for data processing. The ROM 103 is a read-only non-volatile storage medium that stores programs such as firmware. The HDD 104 is a non-volatile storage medium that allows data to be read and written and has a relatively large storage capacity. The HDD 104 stores, for example, an operating system (OS), various control programs, and application programs.

By an arithmetic function of the CPU 101, the post-processing apparatus 3A processes, for example, a control program stored in the ROM 103 and an information processing program (application program) loaded into the RAM 102 from a storage medium such as the HDD 104. Such processing configures a software controller including various functional modules of the post-processing apparatus 3A. The software controller thus configured cooperates with hardware resources of the post-processing apparatus 3A to construct functional blocks that implement functions of the post-processing apparatus 3A. In other words, the CPU 101, the RAM 102, the ROM 103, the HDD 104, and the I/F 105 constitute at least part of a controller 100B serving as a control device that controls the operation of the post-processing apparatus 3A.

The I/F 105 is an interface that connects conveyance roller pairs 10, 11, 14, and 15, a switching plate 20, side fences 24L and 24R, a crimper movement motor 238, a crimper pivot motor 239, a contact-separation motor 32d, a liquid-applier movement motor 137, an application-head pivot motor 150, an application-head movement motor 151, a standby-position sensor 138, a standby-angle sensor 152, a hole punch 132, and an operation panel 110 to the common bus 109. The controller 100B controls, via the I/F 105, the operations of the conveyance roller pairs 10, 11, 14, and 15, the switching plate 20, the side fences 24L and 24R, the crimper movement motor 238, the crimper pivot motor 239, the contact-separation motor 32d, the liquid-applier movement motor 137, the application-head pivot motor 150, the application-head movement motor 151, and the hole punch 132.

The controller 100B acquires detection results from the standby-position sensor 138 and the standby-angle sensor 152 through the I/F 105. Although FIG. 27 illustrates the components of the liquid applier 131 and the edge binder 251 (the crimper 32′) that executes the edge binding, the components that execute the saddle binding are controlled by the controller 100B, like the components of the liquid applier 131 and the edge binder 251 (the crimper 32′) that executes the edge binding.

As illustrated in FIG. 29, the image forming apparatus 2 includes the operation panel 110. The operation panel 110 includes an operation device that receives instructions input by an operator and a display serving as a notifier that notifies the operator of information. The operation device includes, for example, hard keys and a touch screen overlaid on the display. The operation panel 110 acquires information from the user through the operation device and provides information to the user through the display. The post-processing apparatus 3A may include an operation panel 110 similar to the above-described operation panel 110 of the image forming apparatus 2.

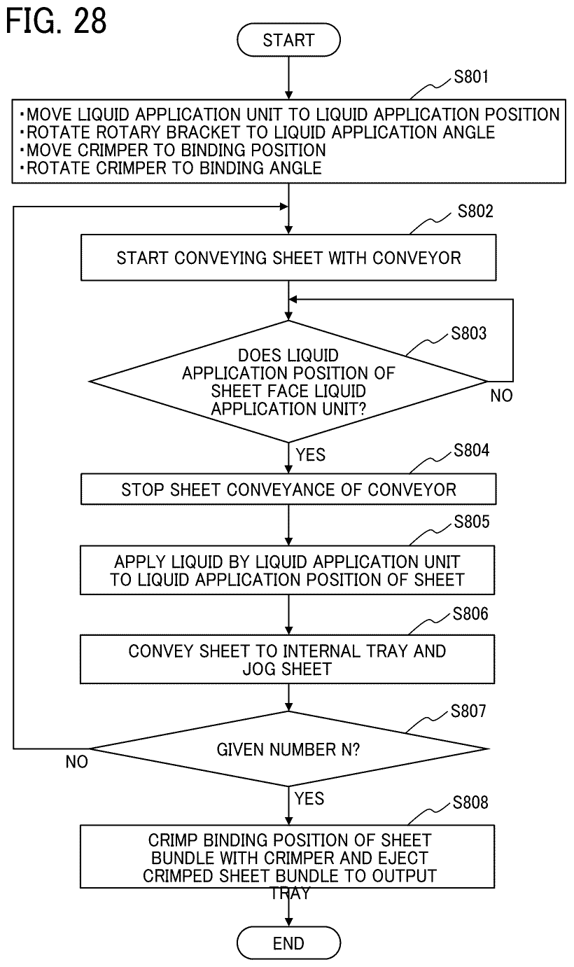

FIG. 28 is a flowchart of post-processing performed by the post-processing apparatus 3A according to another embodiment. Specifically, FIG. 29 is a flowchart of a process of executing the one-point binding illustrated in FIGS. 22A to 22C.

For example, the controller 100B executes the post-processing illustrated in FIG. 28 when the controller 100B acquires an instruction to execute the post-processing from the image forming apparatus 2. In the following description, the instruction to execute the post-processing may be referred to as a “post-processing command.” The post-processing command includes, for example, the number of sheets P of the sheet bundle Pb (referred to as “given number N”), the number of sheet bundles Pb to be subjected to binding processing, the binding position B1 (corresponding to the liquid application position B1), the angle of the binding position B1 (corresponding to the angle of the liquid application position B1), the type of binding process (parallel binding process or oblique binding process), and a process that is executed in parallel with the liquid application process (i.e., punching a hole in the present embodiment). In the following description, the number of sheets P of the sheet bundle Pb may be referred to as a “given number N,” and the number of sheet bundles Pb to be subjected to binding processing may be referred to as “requested number M of copies.” At the start of the post-processing, the liquid application unit 140 is at the standby position HP corresponding to the standby position HP illustrated in FIGS. 22A to 22C whereas the rotary bracket 142 is held at the standby angle (corresponding to the parallel binding posture).

First, in step S801, the controller 100B drives the liquid-applier movement motor 137 to move the liquid application unit 140 (corresponding to a liquid applier) in the main scanning direction such that a liquid application head 146 moves from the standby position HP to a position where the liquid application head 146 can face the liquid application position B1 corresponding to the binding position B1 illustrated in FIGS. 22A to 22C. If the type of the binding process instructed by the post-processing instruction is “oblique binding process,” in step S801, the controller 100B drives the application-head pivot motor 150 to rotate the rotary bracket 142. Thus, the liquid application head 146 is rotated from the standby angle to the liquid application angle corresponding to the “oblique binding posture.” It is ascertained, based on a pulse signal output from a rotary encoder of the liquid-applier movement motor 137, that the liquid application head 146 has reached the position where the liquid application head 146 can face the liquid application position B1. Similarly, it is ascertained, based on a pulse signal output from a rotary encoder of the application-head pivot motor 150, that the liquid application head 146 has reached the liquid application angle. If the type of the binding process instructed by the post-processing instruction is “parallel binding process”, the controller 100B omits the above-described operation of rotating the rotary bracket 142. In other words, the liquid application unit 140 moves in the main scanning direction while holding the rotary bracket 142 at the standby angle.

In step S801, further, the controller 100B drives the crimper movement motor 238 to move the crimper 32′ from the standby position HP to the position where the crimper 32′can face the binding position B1 as illustrated in FIGS. 22A and 22B. Alternatively, if the type of the binding process instructed by the post-processing instruction is “oblique binding process,” in step S801, the controller 100B drives the crimper pivot motor 239 to rotate the crimper 32′ from the standby angle to the crimping angle corresponding to the “oblique binding posture.” It is ascertained, based on a pulse signal output from a rotary encoder of the crimper movement motor 238, that the crimper 32′has reached the position where the crimper 32′ can face the binding position B1. Similarly, it is ascertained, based on a pulse signal output from a rotary encoder of the crimper pivot motor 239, that the crimper 32′ has reached the crimping angle. If the type of the binding process instructed by the post-processing instruction is “parallel binding process,” the controller 100B omits the above-described operation of rotating the crimper 32′. In other words, the crimper 32′moves in the main scanning direction while maintaining the standby angle.

Subsequently, in step S802, the controller 100B drives the conveyance roller pairs 10 and 11 to start conveying the sheet P on which an image is formed by the image forming apparatus 2. In step S803, the controller 100B determines whether the liquid application position B1 on the sheet P has faced the liquid application unit 140 (more specifically, the liquid application head 146). In other words, the controller 100B determines whether the liquid application unit 140 has faced the liquid application position B1 on the sheet P. When the liquid application position B1 on the sheet P has not faced the liquid application head 146 (NO in step S803), the controller 100B repeats the determination in step S803. In other words, the controller 100B continues driving the conveyance roller pairs 10 and 11 until the liquid application position B1 on the sheet P faces the liquid application head 146. By contrast, when the liquid application position B1 on the sheet P has faced the liquid application head 146 (YES in step S803), in step S804, the controller 100B stops the conveyance roller pairs 10 and 11. It is ascertained, based on a pulse signal output from a rotary encoder of a motor that drives the conveyance roller pairs 10 and 11, that the liquid application position B1 on the sheet P has faced the liquid application head 146.

In step S805, the controller 100B causes the liquid applier 131 to execute the process of applying liquid to the liquid application position B1 on the sheet P. More specifically, the controller 100B rotates the application-head movement motor 151 in the first direction to bring the liquid application head 146 into contact with the liquid application position B1 on the sheet P. The controller 100B changes the pressing force of the liquid application head 146 (i.e., the amount of rotation or rotation speed of the application-head movement motor 151) depending on the amount of liquid to be applied to the sheet P.

The amount of liquid that is applied to the sheet P may be the same for all the sheets P of the sheet bundle Pb or may be different for each sheet P. For example, the controller 100B may decrease the amount of liquid applied to a sheet P conveyed later. The amount of rotation of the application-head movement motor 151 may be ascertained based on a pulse signal output from a rotary encoder of the application-head movement motor 151.

In step S806, the controller 100B drives the conveyance roller pairs 10, 11, 14, and 15 to place a sheet P on the internal tray 22. In step S806, the controller 100B moves the side fences 24L and 24R to align the position of the sheet bundle Pb placed on the internal tray 22 in the main scanning direction. In short, the controller 100B performs so-called jogging.

In step S807, the controller 100B determines whether the number of sheets P placed on the internal tray 22 has reached the given number N of sheets indicated by the post-processing command. When the controller 100 determines that the number of sheets P placed on the internal tray 22 has not reached the given number N of sheets (NO in step S807), the controller 100B executes the operations of steps S802 to S806 again.

By contrast, when the controller 100B determines that the number of sheets P that are placed on the internal tray 22 has reached the given number N of sheets (YES in step S807), in step S808, the controller 100 causes the crimper 32′to crimp the binding position B1 (corresponding to the liquid application position B1) on the sheet bundle Pb to which the liquid has been applied by the liquid application unit 140. In addition, in step S808, the controller 100B rotates the conveyance roller pair 15 to eject the crimped sheet bundle Pb to the output tray 26.

The controller 100B drives the liquid-applier movement motor 137 to move the liquid application unit 140 to the standby position HP and drives the crimper movement motor 238 to move the crimper 32′to the standby position HP.

When the post-processing command includes an instruction for forming a plurality of sheet bundles Pb (i.e., the requested number M of copies), as in step S908 in FIG. 9, the controller 100B determines whether the number of sheet bundles Pb ejected to the output tray 26 has reached the requested number M of copies. When the controller 100B determines that the number of the sheet bundles Pb ejected to the output tray 26 has not reached the requested number M of copies, the controller 100B repeats the operations of steps S802 to S808. By contrast, when the controller 100B determines that the number of sheet bundles Pb ejected to the output tray 26 has reached the requested number M of copies, the controller 100B moves the liquid application unit 140 and the crimper 32′to the standby position HP as described above.

The controller 100B of the post-processing apparatus 3A according to the second embodiment illustrated in FIG. 21 is provided separately from the controller 100A of the image forming apparatus 2 as in the configuration of FIG. 1. However, embodiments of the present disclosure are not limited to the above-described configuration. For example, as illustrated in FIG. 30A, the controller 100B of the post-processing apparatus 3 may be disposed in the image forming apparatus 2. Further, as in the configuration of FIG. 30B, the controller 100B of the post-processing apparatus 3 may be integrated with the controller 100A of the image forming apparatus 2.

As in the configuration of FIG. 31A, the controller 100B of the post-processing apparatus 3 may be divided into a controller 100B1 (e.g., a driver system such as a motor) and a controller 100B2 (a detector such as a sensor) according to the function, and the controller 100B2 of the post-processing apparatus 3 may be disposed in the image forming apparatus 2. Further, as in the configuration of FIG. 31B, the controller 100B2 of the post-processing apparatus 3 disposed in the image forming apparatus 2 may be integrated with the controller 100A of the image forming apparatus 2.

As described above, the control method by the controller 100B described above is implemented by cooperation between hardware resources of a computer and a program as computer software. In other words, the control method may be executed by causing an arithmetic device, a storage device, an input device, an output device, and a control device to operate in cooperation with each other based on a program. The program may be written in, for example, a storage device or a storage medium and distributed with the storage device or the storage medium, or may be distributed through, for example, an electric communication line.

Embodiments of the present disclosure are not limited to the above-described embodiments, and numerous additional modifications and variations are possible in light of the teachings within the technical scope of the appended claims. It is therefore to be understood that the above-described embodiments of the present disclosure may be practiced otherwise by those skilled in the art than as specifically described herein. Such modifications and variations are included in the technical scope described in the appended claims.

Aspects of the present disclosure are, for example, as follows.

### First Aspect

A medium processing apparatus includes: a liquid applier to apply liquid to a part of a medium, the medium being at least one medium; a post-processing device to perform processing on a bundle of media including the medium to which the liquid is applied by the liquid applier; a first liquid storage disposed in the liquid applier to store the liquid to be applied by the liquid applier; a second liquid storage to store the liquid to be supplied to the first liquid storage; a liquid supplier to supply the liquid from the second liquid storage to the first liquid storage; a first liquid detector to detect the liquid in the first liquid storage; and a controller to control an operation of the liquid supplier in accordance with a detection result of the first liquid detector. The liquid applier includes a liquid absorber. The liquid absorber has a portion to be partially immersed in the liquid stored in the first liquid storage and another portion to contact the medium to apply the liquid.

### Second Aspect

In the medium processing apparatus according to the first aspect, the liquid absorber is made of an elastic resin including open cells, and the liquid applier draws the liquid from the first liquid storage by a capillary phenomenon of the liquid absorber to fill the liquid absorber with the liquid to apply the liquid.

### Third Aspect

In the medium processing apparatus according to the first or second aspect, the first liquid detector is an electrode sensor including a pair of electrodes applied with a voltage such that the pair of electrodes is energized when the pair of electrodes contact the liquid.

### Fourth Aspect

In the medium processing apparatus according to the third aspect, a first liquid level at which one of the pair of electrodes contacts the liquid is lower than a second liquid level at which the other of the pair of electrodes contacts the liquid.

### Fifth Aspect

In the medium processing apparatus according to any one of the first to fourth aspects, the controller causes the liquid supplier to supply the liquid from the second liquid storage to the first liquid storage when the first liquid detector does not detect the liquid, causes the liquid supplier to stop when the first liquid detector detects the liquid, and causes the first liquid detector to detect the liquid after a first predetermined time has elapsed since stop of the liquid supplier.

### Sixth Aspect

In the medium processing apparatus according to any one of the first to fifth aspects, the controller causes the liquid supplier to perform an operation of supplying the liquid from the second liquid storage to the first liquid storage when the first liquid detector does not detect the liquid after a first predetermined time has elapsed, causes the liquid supplier to stop when the first liquid detector detects the liquid after the operation of the liquid supplier, and notifies an abnormality when the first liquid detector does not detect the liquid after the first predetermined time has elapsed again and when the first liquid detector does not detect the liquid by a time when a second predetermined time elapses after the operation of the liquid supplier is performed again.

### Seventh Aspect

In the medium processing apparatus according to any one of the first to sixth aspects, the pair of electrodes included in the electrode sensor have different lengths from each other.

### Eighth Aspect

In the medium processing apparatus according to any one of the third to seventh aspects, the pair of electrodes of the electrode sensor are inclined with respect to a liquid surface of the liquid.

### Ninth Aspect

The medium processing apparatus according to any one of the first to eighth aspects further includes a second liquid detector to detect the liquid in the second liquid storage. The controller determines a liquid detection threshold value of the first liquid detector in accordance with an output of the second liquid detector.

### Tenth Aspect

In the medium processing apparatus according to the ninth aspect, the controller determines the liquid detection threshold value of the first liquid detector based on an output value of the second liquid detector when the second liquid storage is replenished with the liquid.

### Eleventh Aspect

In the medium processing apparatus according to the ninth or tenth aspect, the controller notifies that the liquid replenished to the second liquid storage is not usable for liquid application when the output value of the second liquid detector is equal to or less than a predetermined value in a state in which the second liquid storage is replenished with the liquid.

### Twelfth Aspect

The medium processing apparatus according to any one of the ninth to eleventh aspects further includes a temperature detector to detect an ambient temperature of at least one of the liquid applier and the first liquid storage. The controller determines the liquid detection threshold value of the first liquid detector based on liquid detection by the second liquid detector when a change in the ambient temperature is equal to or greater than a predetermined fluctuation range.

### Thirteenth Aspect

In the medium processing apparatus according to any one of the first to twelfth aspects, the post-processing device is a crimper to press and deform the bundle of media to bind the bundle of media.

### Fourteenth Aspect

In the medium processing apparatus according to any one of the first to twelfth aspects, the post-processing device is a stapler to cause a needle to penetrate the bundle of media to bind the bundle of media.

### Fifteenth Aspect

An image forming system includes: an image forming apparatus to form images on a plurality of media; and the medium processing apparatus according to any one of the first to fourteenth aspects to perform the processing on the plurality of media on which the images have been formed by the image forming apparatus.

### Sixteenth Aspect

An image forming system includes an image forming apparatus, a medium processing apparatus, and a controller. The image forming apparatus forms an image on a medium. The medium processing apparatus includes: a liquid applier to apply liquid to a part of at least one medium on which an image is formed by the image forming apparatus; a post-processing device to perform processing on a bundle of media including the at least one medium to which the liquid is applied by the liquid applier; a first liquid storage disposed in the liquid applier to store the liquid to be applied by the liquid applier; a second liquid storage to store the liquid to be supplied to the first liquid storage; a liquid supplier to supply the liquid from the second liquid storage to the first liquid storage; a first liquid detector to detect the liquid in the first liquid storage; and a liquid absorber disposed in the liquid applier. The liquid absorber having a portion to be partially immersed in the liquid stored in the first liquid storage and another portion to contact the medium to apply the liquid. The controller controls an operation of the liquid supplier in accordance with a detection result of the first liquid detector.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

This patent application is based on and claims priority to Japanese Patent Application Nos. 2023-003318, filed on Jan. 12, 2023, and 2023-185023, filed on Oct. 27, 2023, in the Japan Patent Office, the entire disclosure of each of which is hereby incorporated by reference herein.

### REFERENCE NUMERALS

1: Image forming system
2: Image forming apparatus
3: Post-processing apparatus
251: Edge binder
36: First liquid application assembly
43: First liquid storage tank
43a: First liquid-level sensor
45: Liquid supply member
451: Liquid application member
452: Liquid immersion portion
45a: Protection member
55: Staple binder
61: Second liquid-applier movement assembly
73: Third liquid storage tank
75: Second liquid supply member
751: Second liquid application member
91: Second liquid storage tank
911: Liquid supply valve
921: Second liquid-storage-tank fixing portion
922: Mount detection sensor
92: Liquid supply pump
93: Liquid supply passage
94: Second liquid-level sensor
95: Temperature sensor
100B: Controller
110: Operation panel

1. A medium processing apparatus, comprising:
a liquid applier configured to apply liquid to a part of at least one medium;
a post-processing device configured to perform processing on a bundle of media, the bundle of media including the at least one medium to which the liquid is applied by the liquid applier;
a first liquid storage included in the liquid applier, the first liquid storage configured to store the liquid to be applied by the liquid applier;
a second liquid storage configured to store the liquid to be supplied to the first liquid storage;
a liquid suppliers configured to supply the liquid from the second liquid storage to the first liquid storage;
a first liquid detector configured to detect the liquid in the first liquid storage; and
processing circuitry configured to control an operation of the liquid supplier in accordance with a detection result of the first liquid detector,
the liquid applier including a liquid absorber, the liquid absorber having a first portion configured to be partially immersed in the liquid stored in the first liquid storage and a second portion configured to contact the at least one medium and apply the liquid.

2. The medium processing apparatus according to claim 1, wherein the liquid absorber comprises:
an elastic resin including a plurality of open cells; and
the liquid applier is further configured to draws the liquid from the first liquid storage by a capillary phenomenon to fill the liquid absorber with the liquid to be applied to the at least one medium.

3. The medium processing apparatus according to claim 1, wherein the first liquid detector is an electrode sensor including a pair of electrodes, the electrode sensor configured to be applied with a voltage such that the pair of electrodes is energized in response to the pair of electrodes contacting the liquid.

4. The medium processing apparatus according to claim 3, wherein a first liquid level at which one electrode of the pair of electrodes contacts the liquid is lower than a second liquid level at which the other electrode of the pair of electrodes contacts the liquid.

5. The medium processing apparatus according to claim 1, wherein the processing circuitry is further configured to:
cause the liquid supplier to supply the liquid from the second liquid storage to the first liquid storage in response to the first liquid detector not detecting the liquid;
cause the liquid supplier to stop supplying the liquid in response to the first liquid detector detecting the liquid; and
cause the first liquid detector to detect the liquid after a first desired time period has elapsed from the stopping of the liquid supplier.

6. The medium processing apparatus according to claim 1, wherein the processing circuitry is further configured to:
cause the liquid supplier to supply the liquid from the second liquid storage to the first liquid storage in response to the first liquid detector not detecting the liquid after a first desired time period has elapsed;
cause the liquid supplier to stop supplying the liquid in response to the first liquid detector detecting the liquid; and
transmit a notification of an abnormality in response to the first liquid detector not detecting the liquid after the first desired time period has elapsed again and in response to the first liquid detector not detecting the liquid by a time in response to a second desired time period elapsing after the liquid supplier starts to supply the liquid again.

7. The medium processing apparatus according to claim 3, wherein the pair of electrodes included in the electrode sensor have different lengths from each other.

8. The medium processing apparatus according to claim 3, wherein the pair of electrodes included in the electrode sensor are inclined with respect to a liquid surface of the liquid.

9. The medium processing apparatus according to claim 1, further comprising:
a second liquid detector configured to detect the liquid in the second liquid storage, wherein
the processing circuitry is further configured to determine a liquid detection threshold value of the first liquid detector in accordance with an output of the second liquid detector.

10. The medium processing apparatus according to claim 9, wherein the processing circuitry is further configured to:
determine the liquid detection threshold value of the first liquid detector based on an output value of the second liquid detector in response to the second liquid storage being replenished with the liquid.

11. The medium processing apparatus according to claim 9, wherein the processing circuitry is further configured to:
transmit a notification indicating that the liquid stored in the second liquid storage is not usable for liquid application in response to an output value of the second liquid detector being equal to or less than a desired value.

12. The medium processing apparatus according to claim 9, further comprising:
a temperature detector configured to detect an ambient temperature of at least one of the liquid applier and the first liquid storage, wherein
the processing circuitry is further configured to determine the liquid detection threshold value of the first liquid detector based on liquid detection by the second liquid detector in response to a change in the ambient temperature being equal to or greater than a desired fluctuation range.

13. The medium processing apparatus according to claim 1, wherein
the post-processing device is a crimper configured to press and deform the bundle of media to bind the bundle of media.

14. The medium processing apparatus according to claim 1, wherein
the post-processing device is a stapler configured to cause a needle to penetrate the bundle of media to bind the bundle of media.

15. An image forming system, comprising:
an image forming apparatus configured to form one or more images on a plurality of media; and
the medium processing apparatus according to claim 1, the medium processing apparatus configured to perform the processing on the plurality of media on which the images have been formed by the image forming apparatus.

16. An image forming system, comprising:
an image forming apparatus configured to form at least one image on at least one medium; and
a medium processing apparatus including,
a liquid applier configured to apply liquid to a part of the at least one medium on which the at least one image is formed by the image forming apparatus,
a post-processing device configured to perform processing on a bundle of media, the bundle of media including the at least one medium to which the liquid is applied by the liquid applier,
a first liquid storage included in the liquid applier, the first liquid storage configured to store the liquid to be applied by the liquid applier,
a second liquid storage configured to store the liquid to be supplied to the first liquid storage,
a liquid supplier configured to supply the liquid from the second liquid storage to the first liquid storage, and
a first liquid detector configured to detect the liquid in the first liquid storage,
the liquid applier including a liquid absorber, the liquid absorber having a first portion to be partially immersed in the liquid stored in the first liquid storage and a portion configured to contact the at least one medium and apply the liquid, and
processing circuitry configured to control an operation of the liquid supplier in accordance with a detection result of the first liquid detector.
